(19) United States
(12) Patent Application Publication
(10) Pub. No.: US 2005/0108444 A1
(43) Pub. Date: May 19, 2005

(54) Method of detecting and monitoring fabric congestion

(76) Inventors: Gary R. Flauaus, Longmont, CO (US); Byron Harris, Longmont, CO (US); Byron Jacquot, Westminster, CO (US)

Correspondence Address: HOGAN & HARTSON LLP, ONE TABOR CENTER, SUITE 1500, 1200 SEVENTEENTH ST, DENVER, CO, 80202, US

(21) Appl. No.: 10/716,858

(22) Filed: Nov. 19, 2003

(51) Int. Cl. G06F 3/00

(52) U.S. Cl. 710/15

(57) ABSTRACT

A system for detecting, monitoring, reporting, and managing congestion in a fabric at the port and fabric levels. The system includes multi-port switches in the fabric with port controllers that collect port traffic statistics. A congestion analysis module in the switch periodically gathers port statistics and processes the statistics to identify backpressure congestion, resource limited congestion, and over-subscription congestion at the ports. A port activity database is maintained at the switch with an entry for each port and contains counters for the types of congestion. The counters for ports that are identified as congested are incremented to reflect the detected congestion. The system includes a management platform that periodically requests copies of the port congestion data from the switches in the fabric. The switch data is aggregated to determine fabric congestion including the congestion level and type for each port and congestion sources.

### BACKGROUND OF THE INVENTION

1. Field of the Invention

The present invention relates generally to methods and systems for monitoring and managing data storage networks, and more particularly, to an automated method and system for identifying, reporting, and monitoring congestion in a data storage network, such as a Fibre Channel network or fabric, in a fabric-wide or network-wide manner.

2. Relevant Background

For a growing number of companies, planning and managing data storage is critical to their day-to-day business. To perform their business and to serve customers requires ongoing access to data that is reliable and quick. Any downtime, or even delays in accessing data, can result in lost revenues and decreased productivity. Increasingly, these companies are utilizing data storage networks, such as storage area networks (SANs), to control data storage costs as these networks allow sharing of network components and infrastructure.

Generally, a data storage network is a network of interconnected computers, data storage devices, and the interconnection infrastructure that allows data transfer, e.g., optical fibers and wires that allow data to be transmitted and received from a network device along with switches, routers, hubs, and the like for directing data in the network. For example, a typical SAN may utilize an interconnect infrastructure that includes connecting cables each with a pair of 1 or 2 Gigabit per second (Gbps) capacity optical fibers for transmitting and for receiving data and switches with multiple ports connected to the fibers and processors and applications for managing operation of the switch. SANs also include servers, such as servers running client applications including data base managers and the like, and storage devices that are linked by the interconnect infrastructure. SANs allow data storage and data paths to be shared, with all of the data being available to all of the servers and other networked components as specified by configuration parameters.

The Fibre Channel (FC) standard has been widely adopted in implementing SANs and is a high-performance serial interconnect standard for bi-directional, point-to-point communication between devices, such as servers, storage systems, workstations, switches, and hubs. Fibre Channel employs a topology known as a “fabric” to establish connections, or paths, between ports. A fabric is a network of one or more FC switches for interconnecting a plurality of devices without restriction as to the manner in which the FC switch, or switches, can be arranged. In Fibre Channel, a path is established between two nodes, where the path's primary task is to transport data, in-band from one point to another at high speed with low latency. FC switches provide flexible circuit/packet switched topology by establishing multiple simultaneous point-to-point connections. Because these connections are managed by the FC switches, or “fabric elements” rather than by the connected end devices or “nodes”, in-band fabric traffic management is greatly simplified from the perspective of the end devices.

A Fibre Channel node, such as a server or data storage device including its node port or “N_Port”, is connected to the fabric by way of an F_Port on an FC switch. The N_Port establishes a connection to a fabric element (e.g., an FC switch) that has a fabric port or an F_Port. FC switches also include expansion ports known as E_Ports that allow interconnection to other FC switches. Edge devices attached to the fabric require only enough intelligence to manage the connection between an N_Port and an F_Port. Fabric elements, such as switches, include the intelligence to handle routing, error detection, and recovery and similar management functions. An FC switch can receive a frame from one F_Port and automatically route that frame to another F_Port. Each F_Port can be attached to one of a number of different devices, including a server, a peripheral device, an I/O subsystem, a bridge, a hub, or a router. An FC switch can receive a connection request from one F_Port and automatically establish a connection to another F_Port. Multiple data transfers happen concurrently through the multiple F_Port switch. A key advantage of packet-switched technology is that it is “non-blocking” in that once a logical connection is established through the FC switch, the bandwidth that is provided by that logical connection can be shared. Hence, the physical connection resources, such as copper wiring and fiber optic cabling, can be more efficiently managed by allowing multiple users to access the physical connection resources as needed.

Despite the significant improvements in data storage provided by data storage networks, performance can become degraded, and identifying and resolving the problem can be a difficult task for a system or fabric manager. For example, a SAN may have numerous switches in a fabric that connects hundreds or thousands of edge devices such as servers and storage devices. Each of the switches may include 8 to 64 or more ports, which results in a very large number of paths that may be utilized for passing data between the edge devices of the SAN. If one path, port, or device is malfunctioning or slowing data traffic, it can be nearly impossible to manually locate the problem. The troubleshooting task is even more problematic because the system is not static as data flow volumes and rates continually change as the edge devices operate differently over time to access, store, and backup data. Recreating a particular operating condition in which a problem occurs can be very time consuming, and in some cases, nearly impossible.

Existing network monitoring tools do not adequately address the need for identifying and monitoring data traffic and operational problems in data storage networks. The typical monitoring tool accesses data collected at the switch to determine traffic flow rates and/or utilization of a path or link, i.e., the measured data traffic in a link or at a port relative to the capacity of that link or port. The monitoring tools then may report utilization rates for various links or ports to the network manager via a user interface or with the use of status alerts, such as when a link has utilization over a specified threshold (e.g., over utilization which is often defined as 80 to 90 percent or higher usage of a link). In some applications, the utilization rates on the links is used to select paths for data in an attempt to more efficiently route data traffic and rates on the links are used to reduce over utilization of links. However, such rerouting of traffic is typically only performed in the egress or transmit direction and is limited to traffic between E_Ports or switches.

Unfortunately, determining and reporting utilization of a link or a port does not describe operation of a storage network or a fabric in a manner that enables a network manager to quickly and effectively identify potential problems. For example, high utilization of a link may be acceptable and expected when data back up operations are being performed and may not slow traffic elsewhere in the system. Also, high utilization may also be acceptable if it occurs infrequently. Further, the use of utilization as a monitoring tool may mislead a network manager to believing there are no problems when data is being slowed or even blocked in a network or fabric. For example, if an edge device such as data storage device is operating too slowly or slower than a link's or path's capacity, the flow of data to that device and upstream of the device in the fabric will be slowed and/or disrupted. However, the utilization of that link will be low and will not indicate to a network manager that the problem is in the edge device connected to the fabric link. Also, utilization will be low or non-existent in a link when there is no data flow due to hardware or other problems in the link, connecting ports, or edge devices. As a result, adjacent devices and links may be highly or over utilized even when these devices are functioning properly. In this case, utilization rates would mislead the network manager into believing that these over utilized links or devices are at the root of the data flow problem, rather than the actual links or devices causing the problem.

Hence, there remains a need for improved methods and systems for detecting and monitoring data flow in a data storage network or in the fabric of a SAN and for identifying, monitoring, and reporting data flow problems and potential sources of such data flow problems to a network manager or administrator. Preferably, such methods and systems would be automated to reduce or eliminate the need for manually troubleshooting complex data storage networks and would be configured to be compatible with standard switch and other fabric component designs.

### SUMMARY OF THE INVENTION

The present invention addresses the above problems by providing a fabric congestion management system. The system is adapted to provide an automated method of detecting, monitoring, reporting, and managing various types of congestion in a data storage network, such as a Fibre Channel storage area network, on both a port-by-port basis in each switch in the network and on a fabric-centric basis. Fabric congestion is one of the major sources of disruption to user operations in data storage networks. The system of the present invention was developed based on the concept that there are generally three types of congestion, i.e., resource limited congestion; over-subscription congestion; and backpressure congestion and that these three types of congestion can be uniquely identified for management purposes. Briefly, a resource limited congestion node is a point within the fabric or at the edge of the fabric that cannot keep up with maximum line rate processing for an extended period of time due to insufficient resource allocation at the node. A node subject to over-subscription congestion or over-utilization is a port where the frame traffic demand consistently exceeds the maximum line rate capacity of the port. Backpressure congestion is a form of second stage congestion often occurring when a link can no longer be used to send frames as a result of being attached to a “slow draining device” or because there is another congested link, port, or device downstream of the link, port, or device.

In order to explain congestion, it is useful to start with a simplistic example: a single link between two ports, where each port could belong to any Fibre Channel node (a host, storage device, switch, or other connected device). When a Fibre Channel link is established, the ports agree upon the parameters that will apply to the link: the rate of transmission and the number of frames the receiving port can buffer. FIG. 12 illustrates a Transmitting (TX) Port on a node with many buffered frames to send, and a Receiving (RX) Port that contains a queue of 4 frame reception buffers. When the link between the ports becomes active, the RX Port will advertise a BB_Credit (Buffer-to-Buffer Credit) value of 4 to the TX Port. For every frame the TX Port sends, it decrements the available TX BB_Credit value by one. When the node attached to the RX Port has emptied one of the RX buffers, it will send the Receiver Ready (R_RDY) primitive signal to the TX Port, which increments the TX BB_Credit by one. If the TX Port exhausts the TX BB_Credit, it must wait for an R_RDY before it may send another frame. While the throughput over the link is related to the established transmission rate, it is also related to the rate of TX BB_Credit recovery. If the receiving node can empty the RX Port's RX buffers at the transmission rate, the RX Port should spend relatively little time with 0 available RX BB_Credit (i.e., with no free receive buffers). A link that spends significant time with 0 TX or RX BB_Credit is likely experiencing congestion. In over-subscription congestion, the demand for the link is greater than the transmission rate, and the TX Port will consistently exhaust TX BB_Credit, however quickly the RX Port can recover the buffers and return R_RDYs. In resource-limited congestion, the RX Port slowly processes the RX Buffers and returns R_RDYs, causing the TX Port to spend significant time waiting for a free buffer resource, lowering overall throughput. Factors causing the RX Port to process the buffers slowly can include attachment to a slow mechanical device, a device malfunction, or attempting to relay the frames on a further congested link. Additionally, each frame in the RX Port queue can spend significant time waiting for attention from the slow device. “Time on Queue” (TOQ) latency is also a useful tool in detecting resource-limited congestion. Higher queuing delays at RX ports can be used as another indicator that the port is congested, while lower queuing delays tend to indicate that the destination port is simply very busy.

To further explain backpressure problems, FIGS. 10 and 11 provide simplified block diagrams of fabric architecture that is experiencing backpressure. FIG. 10 shows a host, a switch, and 3 storage devices. Storage device A is a slow draining device, that is, a device that cannot keep up with line rate frame delivery for extended periods of time. In this example, the host transmits frames for storage devices A, B, and C in that order repeatedly at full line rate and limited only by Buffer-to-Buffer (BB) Credit and R_RDY handshaking.

Assuming there are no other devices attached to the switch, there is no congestion on the egress ports other than possibly on port A. The illustrated example further assumes that frames enqueued for egress ports B and C are immediately sent as they are received and R_RDYs are immediately returned to the host for these frames. Soon, in this example, the switch's ingress port queues appear as shown in FIG. 10. Most of the time, port A's queue contains 16 entries (i.e., the maximum allowed in this simple example) and port B and C's queues are empty. In this configuration, the egress bandwidth for A, B, and C are equal. If operations begin with 16 frames on port A's queue and 0 on B & C's queues, then the data transmission in the illustrated system would have the following pattern: (1) Wait a relatively long period; (2) Storage A (finally) sends an R_RDY to the switch and the switch sends one of 16 frames to Storage A; (3) Switch sends Host an R_RDY and receives a frame to Storage B. Frame immediately sent; (4) Switch sends Host an R_RDY and receives a frame to Storage C. Frame is immediately sent; (5) Switch sends Host an R_RDY and receives a frame for Storage A; and (6) Wait a long time. Then, the process repeats.

Between the “wait” cycles, 3 frames have been sent; one to each storage device thus making the bandwidth equal across the switch's 3 egress ports. The bandwidth is a function of the “wait” referenced above. Although the host is not busy and storage devices B and C are not busy, there is no way to increase their bandwidth using Fibre Channel. Starvation, in this case, is a result of backpressure.

FIG. 11 illustrates an example of backpressue in a multiple switch environment. Shown are 2 hosts, 2 switches, and 2 storage devices. Storage device A is slow, and B is not. Again, this example assumes a maximum of 16 BB_Credits at each switch port and also assumes that frames enqueued on port B's queue in Switch II are always immediately delivered and that storage device B always immediately returns R_RDY back to Switch II. After studying the previous example of FIG. 10, it is easy to see that backpressure is present on ingress ports A for both switches in FIG. 11. Switch II's ingress ISL port turns into a “slow draining device” simply because it's in a backpressure state induced by storage device A. Here, however, the problem is not that Host A is attempting to send data to the fast storage device; rather, a second host is now unable to send data to (fast) storage device B because the paths share a common ISL which is in a backpressure condition.

Some observers have asserted that increasing the BB_Credit limit to a higher value (for example, 60 in the illustrated switch architecture) would help alleviate the problem, but unfortunately, it only delays the onset of the condition somewhat. The difference between 16 and 60 is 44, and at 10 ms per full-length frame at 2 Gbps or 20 ms per full-length frame at 1 Gbps, the problem would arise 440 ms later or 880 ms later, respectively. However, the switch would then hold each frame for a longer period of time increasing the chances that more frames would be timed out in this scenario. As can be seen in FC switch architecture, flow control is based on link credits and frames are not normally discarded. As a result, if TX BB_Credits are unavailable to transmit on a link, data backs up in receive ports. Further, since this backing up of data cannot be acknowledged to the remote sending port with an R_RDY, data rapidly backs up in many remote sending ports that do not recognize the congestion problems and the cycle continues to be repeated, which increases the congestion.

With this explanation of backpressure problems, it will be easier to understand the difficult problems addressed by the methods and systems of the invention. The system of the present invention generally operates at a switch level and at a fabric level with the use of a network management platform or component. Each switch in the fabric is configured with a switch congestion analysis module to pull data from control circuitry at each port, e.g., application specific integrated circuits (ASICs) used to control each port, and detect congestion. Each sampling period the analysis module gathers each port's congestion management statistical data set and then provides a port view of congestion by periodically computing a per port congestion status based on the gathered data. On the switch, a local port activity database (PAD) is maintained and is updated based on the computed congestion state or level after computations are completed, typically each sampling period. Upon request, the analysis module or other component of the switch provides a copy of all or select records in the PAD to a management interface, e.g., a network management platform. Optionally, the analysis module (or other devices in each switch) may utilize Congestion Threshold Alerts (CTAs) to detect ports having a congestion state or level above a configured threshold value within a specified time period. The alert may identify one or more port congestion statistics at a time and be sent to the fabric management platform or stored in logs, either within the switch for later retrieval or at the management platform. Threshold alerts are not a new feature when considered alone, however, with the introduction of the congestion management feature, the use of alerts is being extended with the CTAs to include the newly defined set of congestion management statistics.

At the fabric level, a fabric congestion analysis module may also be provided on a network management platform, such as a server or other network device linked to the switches in the fabric or network. The fabric module and/or other platform devices act to store and maintain a central repository of port-specific congestion management status and data received from switches in the fabric. The fabric module also functions to calculate changes or a delta in the congestion status or states of the ports, links, and devices in the fabric over a monitoring or detection period. In this manner, the fabric module is able to determine and report a fabric centric congestion view by extrapolating and/or processing the port-specific history and data and other fabric information, e.g., active zone set data members, routing information across switch back planes (e.g., intra-switch) and between switches (e.g., inter-switch), and the like, to effectively isolate congestion points and likely sources of congestion in the fabric and/or network. In some embodiments, the fabric module further acts to monitor fabric congestion status over time, to generate a congestion display for the fabric to visually report congestion points, congestion levels, and congestion types (or to otherwise provide user notification of fabric congestion), and/or to manage congestion in the fabric such as by issuing commands to one or more of the fabric switches to control traffic flow in the fabric.

Additionally, the understanding that there are multiple forms of congestion is useful for configuring operation of the system to more effectively identify the congestion states of specific devices, links, and ports, for determining the overall congestion state of the fabric (or network), and for identifying potential sources or causes of the congestion (such as a faulty or slow edge device). While the specific mechanisms may vary with the ASIC in the port, tools or mechanisms are typically available to the system at each port in a switch to monitor or gather statistics on the following: TX BB_Credit levels at the egress (or TX) ports that are transmitting data out of the switch; RX BB_Credit levels at the ingress (or RX) ports receiving data into the switch; link speed (such as 1 Giga bit per second (Gbps) or 2 Gbps); link distance to ensure adequate RX BB_Credit allocation; link utilization statistics to establish throughput rates such as characters per second; “Time on Queue” (TOQ) values providing queuing latency statistics; and link error statistics (e.g., bit errors, bad word counts, CRC errors) to allow detection and recovery of lost BB_Credits.

With a basic understanding of the system of the invention and its components, it may now be useful to discuss briefly how congestion detection is performed within the system. When real device traffic in a fabric is fully loading a link, “TX BB_Credit=0” conditions are detected quite often because much of the time the frame currently being transmitted is the frame which just consumed the last TX BB_Credit for a port. However, based upon BB_Credit values alone, it would be improper to report the detection of congestion, e.g., a slow-draining device or a downstream over-utilized link. In contrast, if “TX BB_Credit=0” conditions are detected at a port but link-utilization is found to be low, then chances are good that a slow-draining device, a congested downstream link, and/or a long-distance link configured with insufficient BB_Credit have been identified by the switch congestion analysis module. If “TX BB_Credit=0” conditions are persistently detected and link-utilization is concurrently found to be high, then chances are high that an over-subscribed device or an over-utilized link has been correctly identified by the analysis module. If link utilization is determined to be high, then a solution may be to provide additional bandwidth to end or edge devices so link utilization drops (e.g., over-utilization is addressed). However, high queuing latency statistics, when available, can be used by the analysis module as an indicator that the associated destination port is subject to over-subscription congestion versus just being acceptably busy. Addressing such congestion may require adding additional inter-switch links (ISLs) between switches in the fabric, replacing existing lower speed ISLs with higher speed ones, and the like. The analysis module can use other events, such as a lost SOFC delimiter at the beginning of a frame or lost receiver ready primitive signals (“R_RDYs”) at a receive port due to bit errors over extended periods of otherwise normal operation to detect low TX BB_Credit levels and possible link congestion.

Because it is important to monitor port statistics over time to detect congestion, the switch congestion analysis module maintains a port activity database (PAD) for the switch. The PAD preferably includes an entry for every port on the switch. Each entry includes fields indicating the port type (i.e., F_Port, FL_Port, E_Port, and the like), the current state of the port (i.e., offline, active, and the like), and a recent history of congestion-related statistics or activity. Upon request from a network management platform or other management interface, the switch provides a copy of the current PAD in order to allow the network management platform to identify “unusual” or congestion states associated with the switch. At this point, the network management platform, such as via the fabric congestion analysis module, correlates the new PAD information with previous reports from this and possibly other switches in the fabric. Using the information in PADs from one or more switches comprising the monitored fabric, the network management platform functions to piece together over a period of time a fabric congestion states display that can be provided in a graphical user interface on a user's monitor. The congestion states display is configured to show a user an overview of recent or current congestion states, congestion levels, and congestion types with the fabric shown including the edge devices, the switches, and the connecting links. In one embodiment, message boxes are provided in links (or at devices) to provide text messaging indicating the type of congestion detected, and further, colors or other indicators are used to illustrate graphically the level of congestion detected (e.g., if three levels of congestion are detected such as low, moderate, and high, three colors, such as green, yellow, and red are used to indicate these congestion levels).

More particularly, the present invention provides a switch for use in a data storage network for use in detecting and monitoring congestion at the port level. The switch includes a number of I/O ports that have receiving and transmitting devices for receiving and transmitting digital data from the port (e.g., in the RX and TX directions) and a like number of control circuits (e.g., ASICs) associated with the ports. The control circuits or circuitry function to collect data traffic statistics for each of the ports. The switch further includes memory that stores a congestion record (or entry in a port activity database) for each of the ports. A switch congestion analysis module is provided that acts to gather portions of the port-specific statistics for each port, to perform computations with the statistics to detect congestion at the ports, and to update the congestion records for the ports based on any detected congestion. The module typically acts to repeat these functions once every sample period, such as once every second or other sample time period. In one embodiment, the congestion records include counters for a number of congestion types and updating the records involves incrementing the counters for the ports in which the corresponding type of congestion is detected. The types of congestion may include backpressure congestion, resource limited congestion, and over-subscription congestion.

According to another aspect of the invention, the switch described above is a component of a fabric congestion management system that further includes a network management platform. The management platform is adapted to request and receive the congestion data or portions of the port-specific data from the switch (and other switches when present in the system) at a first time and at a second time. The management platform then processes the congestion data from the first and second times to determine a congestion status of the fabric, which typically includes a congestion level for each port in the fabric. In some embodiments, the type of congestion is also provided for each congested port. The management platform is adapted for determining the delta or change between the congestion data between the first and second times and to use the delta along with the other congestion data to determine the levels and persistence of congestion and, significantly, along with additional algorithms, to determine a source of the congestion in the fabric. In some cases, the source is identified, at least in part, based on the types of congestion being experienced at the ports. The management platform is further adapted to generate a fabric congestion status display for viewing in a user interface, and the display includes a graphical representation of the fabric along with indicators of congestion levels and types and of the source of the congestion.

### BRIEF DESCRIPTION OF THE DRAWINGS

FIG. 1 is a simplified block diagram of a fabric congestion management system according to the present invention implemented in a Fibre Channel data storage network;

FIG. 2 is a logic block diagram of an exemplary switch for use in the system of FIG. 1 and configured for monitoring congestion for each active port in the switch and reporting port congestion records to an external network management platform;

FIG. 3 is a flow chart of a general fabric congestion management process implemented by the system of FIG. 1;

FIG. 4 illustrates an exemplary port congestion detection and monitoring method performed by the switches of FIGS. 1 and 2;

FIG. 5 illustrates one embodiment of a method of detecting and monitoring congestion in a data storage network on a fabric centric basis that is useful for identifying changes in fabric congestion and for identifying likely sources or causes of congestion;

FIG. 6 illustrates in a logical graph format congestion detection (or possible congestion port states) for an F_Port of a fabric switch;

FIG. 7 illustrates in a manner similar to FIG. 6 congestion detection (or possible congestion states) for an E_Port of a fabric switch;

FIGS. 8 and 9 illustrate embodiments of displays that are generated in a graphical user interface by the network management platform to first display a data storage network that is operating without congestion (or prior to congestion detection and monitoring is performed or implemented) and second display the data storage network with congestion indicators (e.g., labels, boxes and the like along with colors or other tools such as animation or motion) to effectively provide congestion states of the entire fabric including fabric components (e.g., links, switches, and the like) and edge devices;

FIGS. 10 and 11 illustrate simplified switch architectures in which backpressure is being experienced; and

FIG. 12 illustrates in block diagram form communication between a transmitting node and a receiving node.

### DETAILED DESCRIPTION OF THE PREFERRED EMBODIMENTS

The present invention is directed to an improved method, and associated computer-based systems, for detecting, reporting, monitoring, and, in some cases, managing congestion in a data storage network. The present invention addresses the need to correlate statistical data from many sources or points within a fabric or network, to properly diagnose port and fabric congestion, and to identify potential sources of congestion. To this end, the invention provides a fabric congestion management system with switches running a switch congestion analysis module that work to detect and monitor port congestion at each switch. The switch modules work cooperatively with a network or fabric management platform that is communicatively linked to each of the switches to process the port or switch specific congestion data to determine fabric wide congestion levels or states, to report determined fabric congestion status (such as through a generated congestion state display), and to enable management of the fabric congestion. The system and methods of the invention are useful for notifying users (e.g., fabric or network administrators) of obstructions within a fabric that are impeding normal flow of data or frame traffic. The system provides the ability to monitor the health of frame traffic within a fabric by periodically monitoring the status of the individual ports within a fabric including end nodes (i.e., N_Ports), by monitoring F and FL_Ports, and between switches, by monitoring E_Ports.

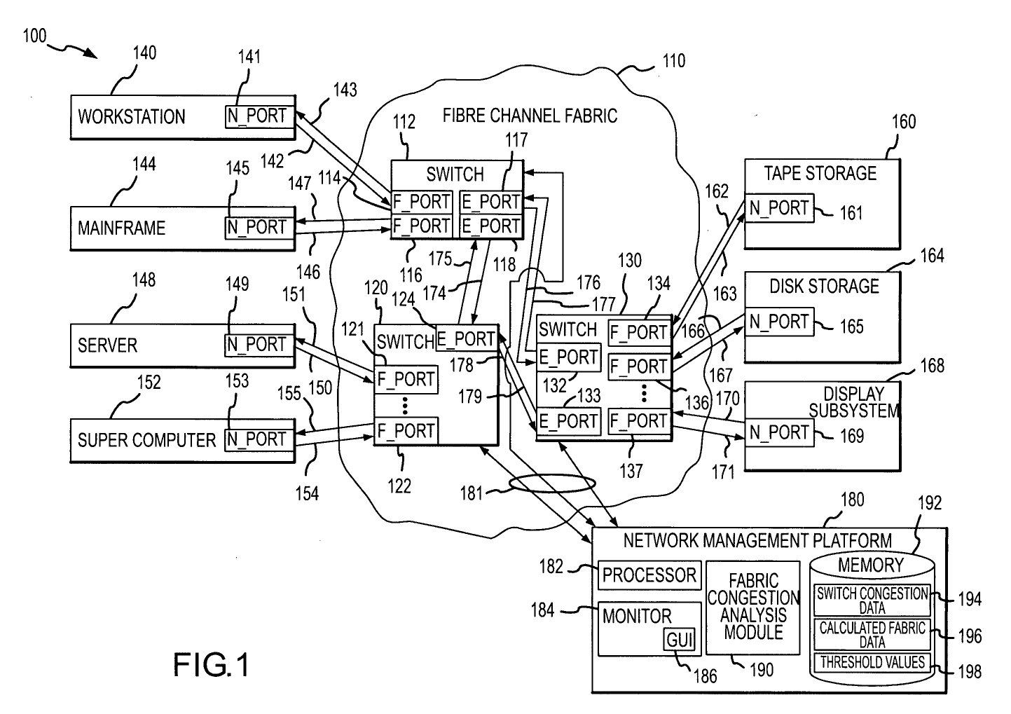

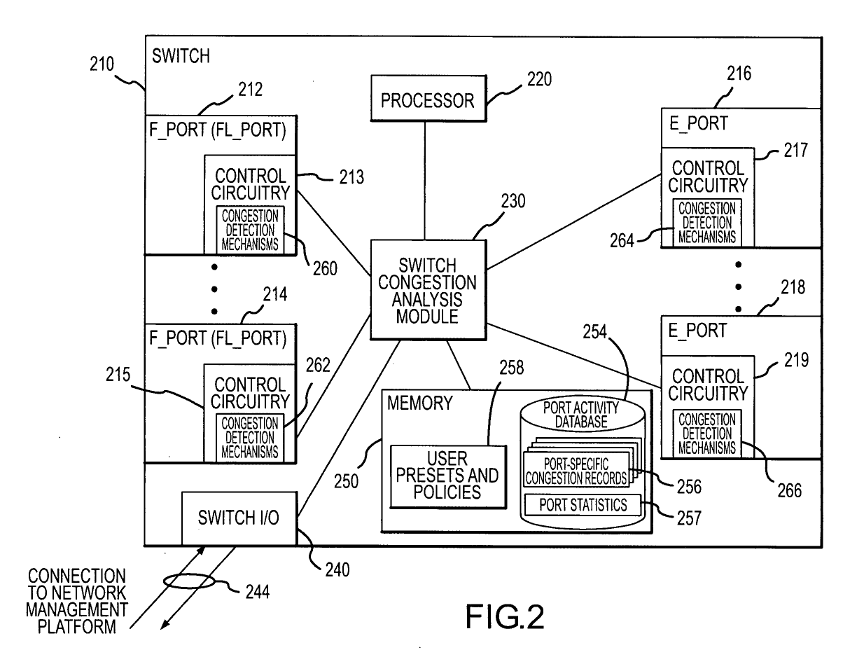

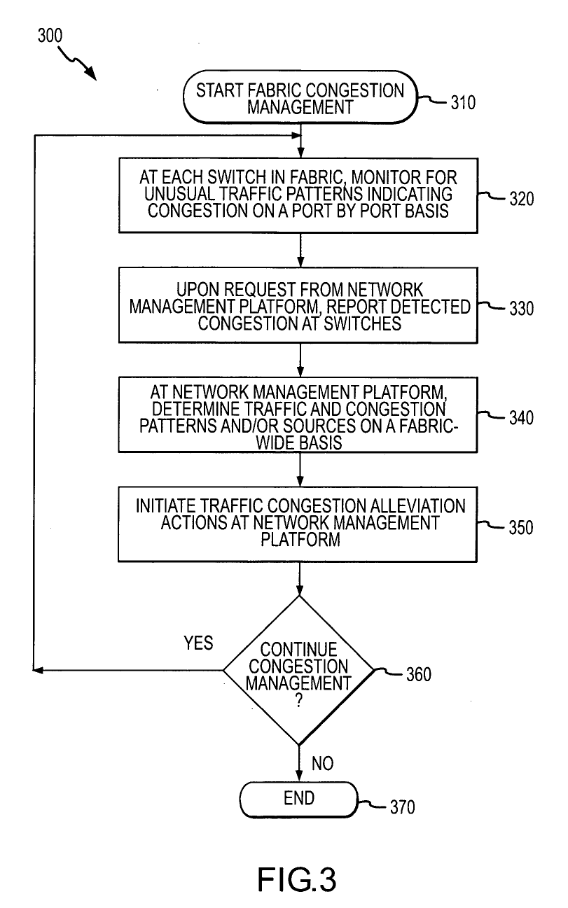

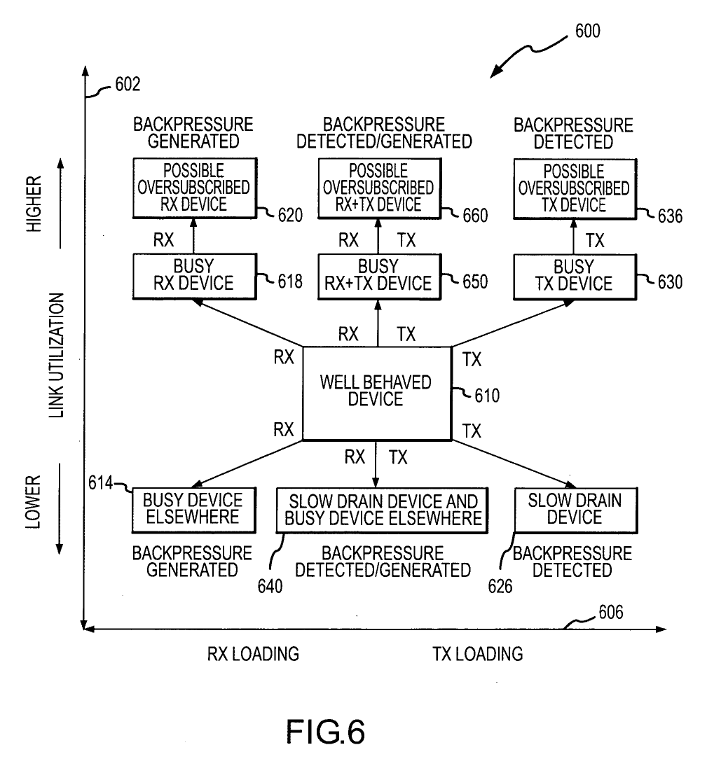

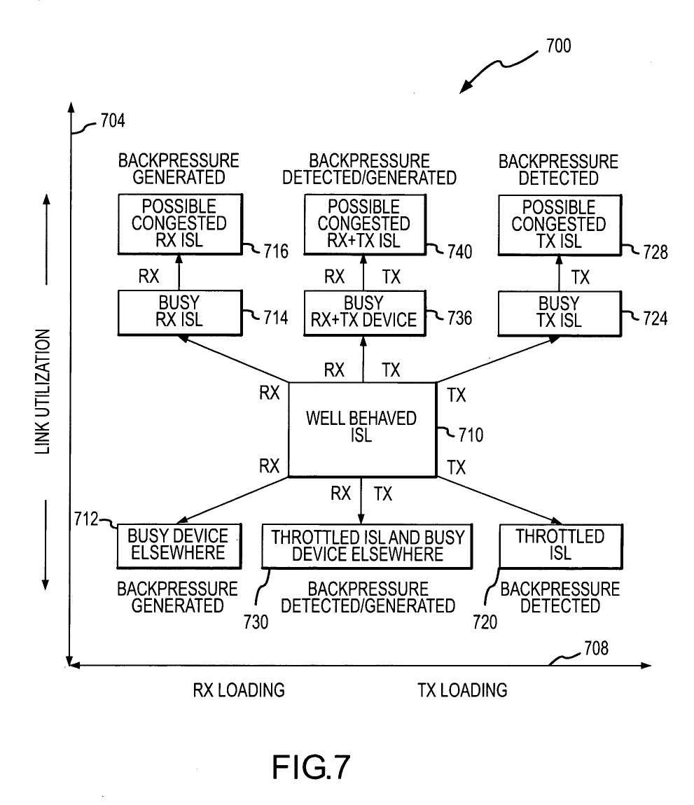

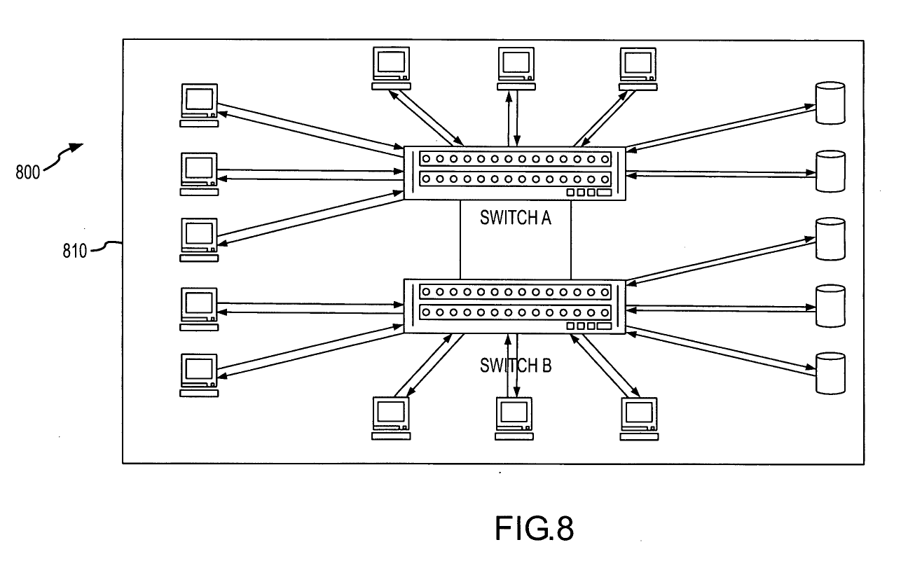

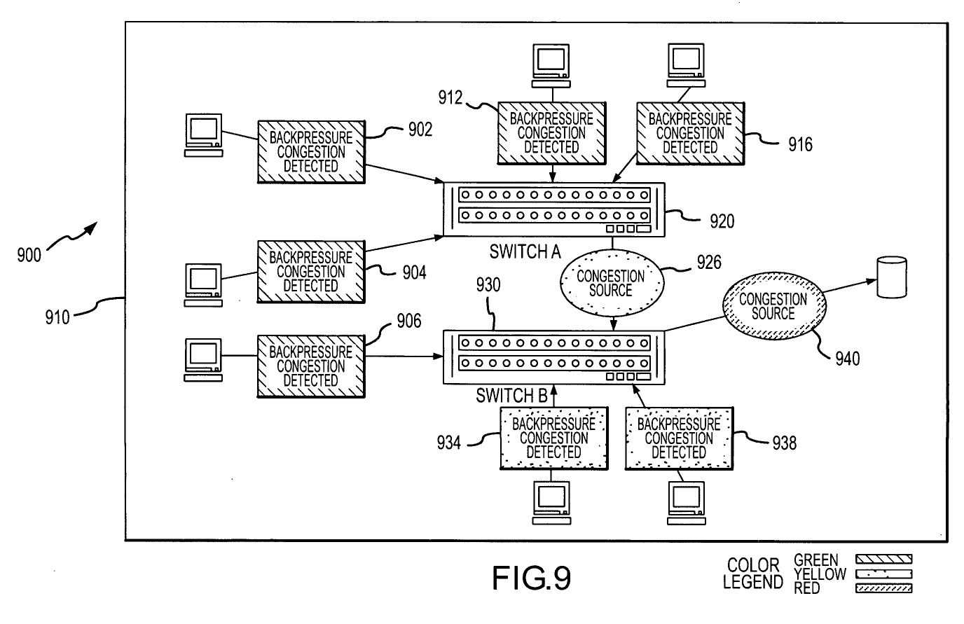

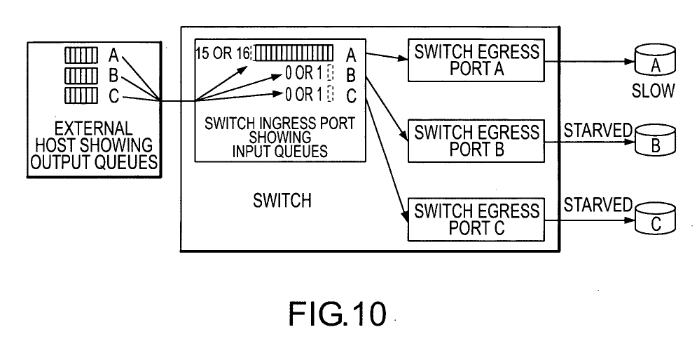

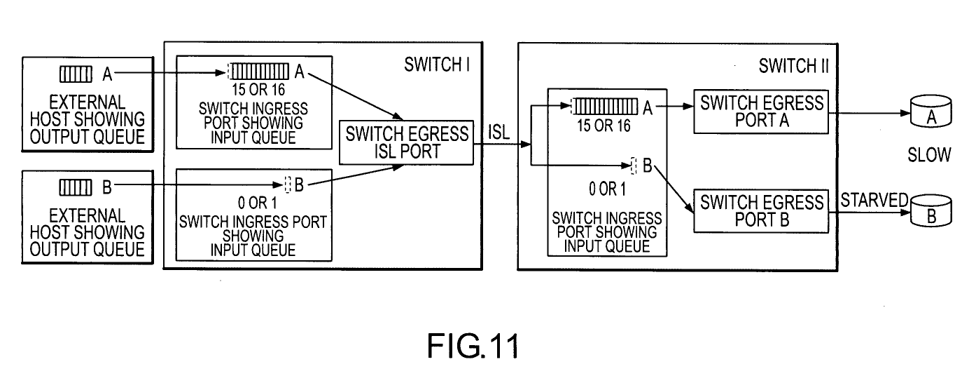

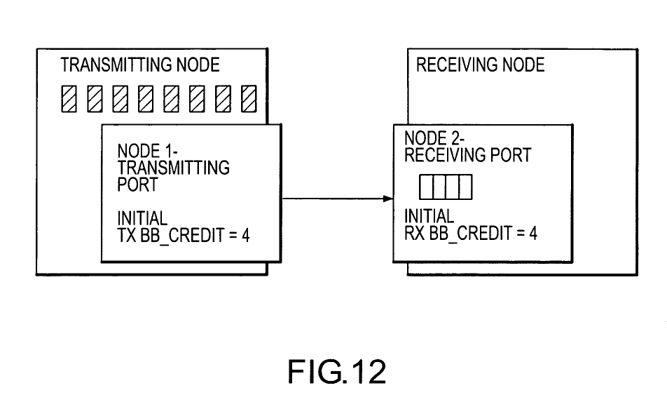

Grasping the nuances of fabric congestion detection and management can be difficult, and therefore, prior to describing specific embodiments and processes of the invention, a discussion is provided of possible sources or categories of fabric congestion that are used within the system and methods of the invention. Following this congestion description, a data storage management system is described with reference to FIG. 1, with one embodiment of a switch for use in the system being described with reference to FIG. 2. FIGS. 3-5 are provided to facilitate description of the fabric congestion detection, monitoring, reporting, and management processes of the invention at the switch and fabric-wide levels. FIGS. 6 and 7 illustrate in logical graph form the detection of congestion at F and E_Ports, respectively, with further discussion of the use of congestion categorization to facilitate reporting and management activities. FIGS. 8 and 9 provide displays that are generated by the network management platform to enable a user to monitor via a GUI the operating status of a monitored fabric, i.e., fabric congestion states, types, and levels.

According to one aspect of the invention, the possible sources of congestion within a fabric are assigned to one of three main congestion categories: resource limited congestion; over-subscription congestion; and backpressure congestion. Using these categories enhances the initial detection of congestion issues at the switches and also facilitates management or correction of detected congestion at a higher level such as at the fabric or network level.

In the resource limited category of congestion, a resource limited node is a point within the fabric (or at an edge of the fabric) identified as failing to keep up with the maximum line rate processing for an extended period of time due to insufficient resource allocation at the node. The reasons an N_Port may be resource limited include a deficient number of RX BB_Credits, limited frame processing power, slow write access for a storage node, and the like. While the limiting resource may vary, the result of a node having limited resources is that extended line rate demand upon the port will cause a bottleneck in the fabric, i.e., the node or port is a source of fabric congestion. One example of resource limited congestion is an N_Port that is performing below line rate demand over a period of time and such an N_Port can be labeled a “slow drain device.” A node in the resource limited congestion category causes backpressure to be felt elsewhere in the fabric. Detection of a resource limited node involves identifying nodes or ports having low TX link utilization while concurrently having a high ratio of time with no transmit credit.

In the over-subscription category of congestion, an over-subscribed node is a port in which it is determined that the frame traffic demand over a period of time exceeds the maximum line rate capacity of the port. An over-subscribed port is not resource bound, but nevertheless is unable to keep up with the excessive number of frame requests it is being asked to handle. Similar to a node in the resource limited category, an over-subscribed node may generate backpressure congestion that is felt elsewhere in the fabric, e.g., in adjacent or upstream links, ports, and/or devices. An over-subscribed port is detected in part by identifying high TX link utilization, a concurrent high ratio of time with no transmit credit, and possibly an extended queuing time at ports attempting to send frames to the over-subscribed node.

In contrast to the other two categories, fabric backpressure congestion is a form of second stage congestion, which means it is removed one or more hops from the actual source of the congestion. When a congested node exists within a fabric, neighboring nodes are unable to deliver frames to or through the congested node and are adversely affected by the congestion source's inability to receive new frames in a timely manner. The resources of these neighboring nodes are quickly exhausted because they are forced to retain their frames rather than transmitting the data. The neighboring nodes themselves become unresponsive to the reception of new frames and become congestion points. In other words, a node suffering from backpressure congestion may itself generate backpressure for its upstream neighboring or linked nodes. In this manner, the undesirable effects of congestion ripple quickly through a fabric even when congestion is caused by a single node or device, and this rippling effect is considered backpressure congestion and identified by low RX link utilization and a concurrent high ratio of time with no receive credit.

In a congested fabric, there is a tendency for a significant percentage of the buffering resources to accumulate behind a single congested node either directly or due to backpressure. With one congestion point being able to affect the wellness of the entire fabric, it is apparent that being not only able to detect symptoms of congestion, but also to locate sources of congestion is of vital importance because without knowing the cause an administrator has little chance of successfully managing or addressing fabric congestion. Further, in Class 3 Fibre Channel networks, the majority of traffic is not acknowledged, and hence, a node that is sourcing frames into a fabric or an ISL forwarding frames within a fabric have very limited visibility into which destination nodes are efficiently receiving frames and which are stalled or congested, which causes congestion to grow as frames continue to be transmitted to or through congested nodes.

FIG. 1 illustrates a fabric congestion management system 100 according to the invention implemented within Fibre Channel architecture, such as a storage area network (SAN). The illustrated system 100 is shown as a block diagram and presents a relatively simple SAN for ease in discussing the invention but not as a limitation as it will be understood that the invention may be implemented in a single switch SAN or a much more complicated SAN or other network with many edge devices and numerous switches, directors, and other devices, such as a “fabric” 110 allowed or enabled by Fibre Channel which provides an active, intelligent interconnection scheme. In general, the fabric 110 includes a plurality of fabric-ports (F_Ports) that provide for interconnection to the fabric and frame transfer between a plurality of node-ports (N_Ports) attached to associated edge devices that may include workstations, super computers and/or peripherals. The fabric 110 further includes a plurality of expansion ports (E_Ports) for interconnection of fabric devices such as switches. The fabric 110 has the capability of routing frames based upon information contained within the frames. The N_Port manages the simple point-to-point connection between itself and the fabric. The type of N_Port and associated device dictates the rate that the N_Port transmits and receives data to and from the fabric 110. Each link has a configured or negotiated nominal bandwidth, i.e., a bit rate that is the maximum at which it can transmit.

As illustrated, the system 100 includes a number of edge devices, i.e., a work station 140, a mainframe 144, a server 148, a super computer 152, a tape storage 160, a disk storage 164, and a display subsystem 168, that each include N_Ports 141, 145, 149, 153, 161, 165, and 169 to allow the devices to be interconnected via the fabric 110. The fabric 110 in turn includes switches 112, 120, 130 with F_Ports 114, 116, 121, 122, 134, 136, 137 for connecting the edge devices to the fabric 110 via bi-directional links 142, 143, 146, 147, 150, 151, 154, 155, 162, 163, 166, 167, 170, 171. The function of the fabric 110 and the switches 112, 120, 130 is to receive frames of data from a source N_Port 141, 145, 149, 153 and using FC or other protocol, to route the frames to a destination N_Port 161, 165, 169. The switches 112, 120, 130 are multi-port devices in which each port is separately controlled as a point-to-point connection. The switches 112, 120, 130 include E_Ports 117, 118, 124, 132, 133 to enable interconnection via paths or links 174, 175, 176, 177, 178, 179.

During operation of the system 100, the operating status in the form of congestion states, levels, and types are monitored for each active port in the switches 112, 120, and 130 and on a fabric centric basis. At the switches 112, 120, 130, mechanisms are provided at each switch for collecting port-specific statistics, for processing the port statistics to detect congestion, and for reporting congestion information to the network management platform 180 via links 181 (e.g., inband, out of band, Ethernet, or other useful wired or wireless link). The network management platform 180 requests and processes the port congestion data from each switch periodically to determine existing fabric congestion status, to determine changes or deltas in the congestion status over time, and for reporting congestion data to users. To this end, the network management platform 180 includes a processor 182 useful for running a fabric congestion analysis module 190 which functions to perform fabric centric congestion analysis and reporting functions of the system 100 (as explained with reference to FIGS. 3-5). Memory 192 is provided for storing requested and received congestion data 194 from the switches, for storing any calculated (or processed) fabric congestion data 196, and for storing default and user input congestion threshold values 198. A user, such as a network or fabric administrator, views congestion reports, congestion threshold alerts, congestion status displays, and the like created by the fabric congestion analysis module 190 on the monitor 184 via the GUI 186 (or other devices not shown).

FIG. 2 illustrates an exemplary switch 210 that may be used within the system 100 to perform the functions of collecting port data, creating and storing port congestion data, and reporting the data to the network management platform 180 or other management interface (not shown). The switches 210 may take numerous forms to practice the invention and are not limited to a particular hardware and software configuration. Generally, however, the switch 210 is a multi-port device that includes a number of F (or FL) ports 212, 214 with control circuitry 213, 215 for connecting via links (typically, bi-directional links allowing data transmission and receipt concurrently by each port) to N_Ports of edge devices. The switch 210 further includes a number of E_Ports 216, 218 with control circuitry 217, 219 for connecting via links, such as ISLs, to other switches, directors, hubs, and the like in a fabric. The control circuitry 213, 215, 217, 219 generally takes the form an application specific integrated circuit (ASIC) that implements Fibre Channel standards and also that provides one or more congestion detection mechanisms 260, 262, 264, 266 useful for gathering port information or port-specific congestion statistics that can be reported to or retrieved periodically by a switch congestion analysis module 230. As will become clear, the specific tools 260, 262, 264, 266 provided varies somewhat between vendors of ASICs and these differences are explained in more detail below. However, nearly any ASIC may be used for the control circuitry 213, 215, 217, 219 to practice the invention.

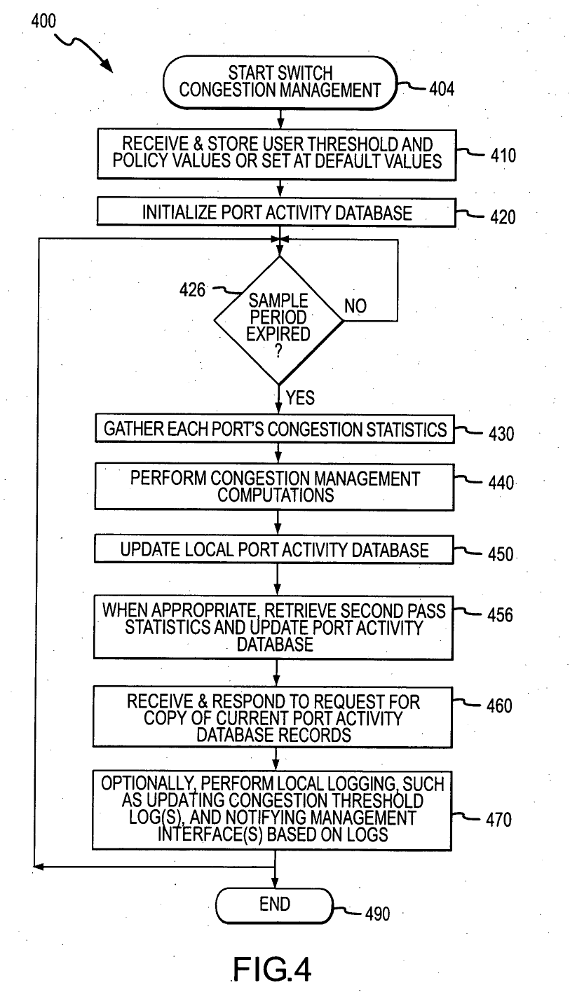

The switch congestion analysis module 230 is generally software run by the switch processor 220 and provides the switch congestion detecting and monitoring functions, e.g., those explained in detail below with reference to FIG. 4. Briefly, the module 230 acts once a sampling period to pull a set of port statistics from the congestion detection mechanisms 260, 262, 264, 266. Memory 250 of the switch 210 is used by the module 230 to store a port activity database (PAD) 254 that is used for storing these retrieved port statistics 257. Additionally, a set of port-specific congestion records 256 comprising a number of fields for each port that facilitate tracking of congestion data (such as information computed or incremented by the module 230) and other useful information for each port. The memory 250 further stores user presets and policies 258 that are used by the module 230 in determining the contents of the PAD 254 and specifically, the port records 256. Typically, non-volatile portions of memory 250 are utilized for the presets and policies 258 and volatile portions are used for the PAD 254. A switch input/output (I/O) 240 is provided for linking the switch 210 via link 244 to a network management platform, and during operation, the platform is able to provide user-defined presets and policies 258 and retrieve information from the PAD 254 for use in fabric centric congestion detection and monitoring. Of course, in some embodiments, management frames from external (F, FL, and E) ports, i.e., ports external to a particular switch, can be routed to the internal port by using special FC destination addresses contained in the frame header. In these embodiments, for example, one switch 112, 120, 130 in the system 100 might be used to monitor two or more of the switches rather than only monitoring its internal operations.

With this general understanding of the system 100, the methods of congestion detection, monitoring, reporting, and management are described in detail with reference to FIGS. 3-9 (along with further reference to FIGS. 1 and 2). FIG. 3 illustrates the broad congestion management process 300 implemented during operation of the system 100. As shown, fabric congestion management starts at 310 with initial configuration of the data storage system 100 for fabric congestion management. Typically, a switch congestion analysis module 230 is loaded on each switch 210 in a monitored fabric. Additionally, at 310, memory 250 may be configured with a PAD 254 and may store user presets and policies 258 for use in monitoring and detecting congestion at a port and switch level. The network management platform 180 is also configured for use in the system 100 with loading of a fabric congestion analysis module (or modification of existing network management applications) 180 to perform the fabric congestion detection and congestion management processes described herein. Also, memory 192 at the platform 180 is used to store default or user-provided threshold values at 310.

At 320, each switch 112, 120, 130 in the fabric 110 operates to monitor for unusual traffic patterns at each active port that may indicate congestion at that port. Switch level congestion detection and monitoring is discussed in detail with reference to FIGS. 4, 6, and 7. Briefly, however, monitoring for unusual traffic patterns 320 can be considered an algorithm that is based upon the premise that during extended periods of traffic congestion within a fabric one or more active ports will be experiencing one or more “unusual” conditions and that such conditions can be effectively detected by a switch congestion analysis module 230 running on the switch 210 (in connection with congestion detection mechanisms or tools 260, 262, 264, 266 provided in port control circuitry 213, 215, 217, 219).

The objects or statistics that can be monitored to detect congestion may vary with the type of port and/or with the ASICs or control circuitry provided with each port. The following objects associated with ports are monitored in one implementation of the process 300 and system 100: (1) port statistic counters associated with counting bit errors, received bad words and bad CRC values as these statistics are often related to a possible loss of SOFC delimiters and/or R_RDY primitive signals over time; (2) total frame counts received and transmitted over recent time intervals with these statistics being used to determine link utilization (frames/second) indicators; (3) total word counts received and transmitted over recent time intervals, with these statistics providing information for determining additional link utilization (bytes/second) indicators; (4) TX BB_Credit values at egress ports and time spent with BB_Credit values at zero for backpressure detection; (5) RX BB_Credit values at ingress ports and time spent with BB_Credit values at zero for backpressure generation detection; (6) TOQ values to monitor queuing latency at ingress or RX ports; (7) destination queue frame discard statistics; (8) Class 3 Frame Flush count register(s); and (9) destination statistics per RX or ingress port to destination ports such as number of frames sent to destination, average queuing delay for destination frames, and the like.

The switch congestion analysis module 230 operates at 320 (alone or in conjunction with the control circuitry in the ports and/or components of the switch management components) to process and store the above statistics to monitor for congestion or “unusual” traffic patterns at each port. Step 320 may involve processing local Congestion Threshold Alerts (CTAs) associated with frame traffic flow in order to determine such things as link quality and link utilization rates. Current TX BB_Credit related registers may be monitored to determine time spent with “TX BB_Credit=0” conditions. Similarly, Current RX BB_Credit related registers are monitored at 320 to determine time spent with “RX BB_Credit=0” conditions. The analysis module 230 may further monitor Class 3 Frame Flush counters, sweep (when available) Time on Queue (TOQ) latency values periodically to detect destination ports of interest, and/or check specific destination statistics registers for destination ports of interest. Note, step 320 may involve monitoring some or all of these statistics in varying combinations with detection of congestion-indicating traffic patterns at each port of a switch being the important process being performed by the switch congestion analysis module 230 during step 320. The results of monitoring at 320 are stored in the port activity database (PAD) 254 in port-specific congestion records 256 (with unprocessed statistics 257 also being stored, at least temporarily, in memory 250). The PAD contains an entry for every port on the switch with each entry including variables or fields of port information and congestion specific information including an indication of the port type (e.g., F_Port, FL_Port, E_Port, and the like), the current state of the port (e.g., offline, active, and the like), and a data structure containing information detailing the history of the port's recent activities and/or traffic patterns. Step 320 is typically performed on an ongoing basis during operation of the system 100 with the analysis module 230 sampling or retrieving port-specific statistics once every congestion detection or sampling period (such as once every second but shorter or longer time intervals may be used).

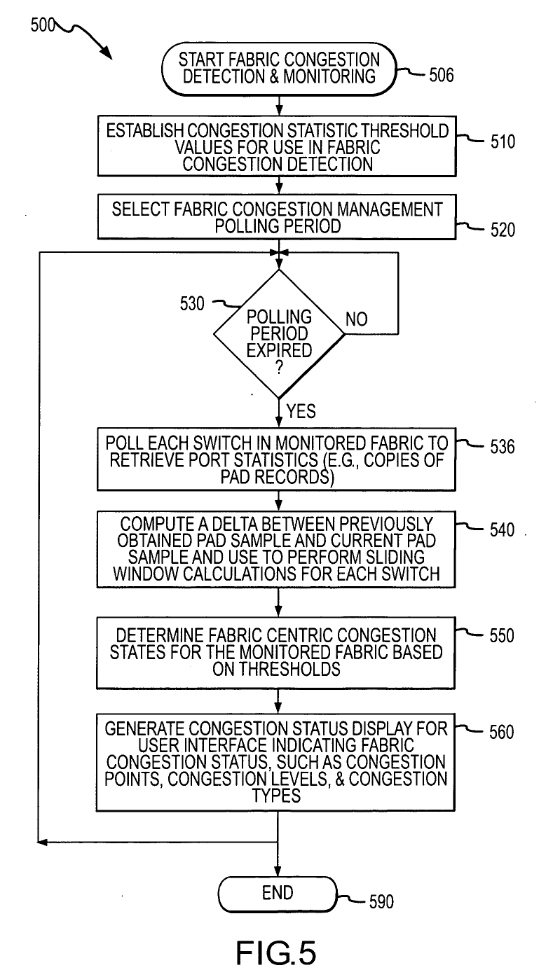

At 330, detected port congestion or congestion statistics 256 from the PAD 254 are reported by one or more switches 210 by the switch congestion analysis module 230. Typically, the network management platform 180 repeats the step 330 periodically to be able to determine congestion patterns at regular intervals, e.g., congestion management or monitoring intervals that may be up to 5 minutes or longer. At 330, an entire copy of the PAD 254 may be provided or select records or fields of the congestion records 256 may be provided by each or selected switches in the fabric. At 340, the fabric congestion analysis module 190 operates to determine traffic and congestion patterns and/or sources on a fabric-wide basis. The analysis module 190 uses the information from the fabric switches to determine any congestion conditions within the switch, between switches, and even at edge devices connected to the fabric. Generally, step 340, involves correlating newly received information from the switch PADs with previously received data or reports sent by or collected from the switch congestion analysis modules 230 and/or comparison of the PAD data with threshold values 198. The results of the fabric-wide processing are stored as calculated fabric data 196 in platform memory 192 and a congestion display (or other report) is generated and displayed to users via a GUI 186 (with processing at 340 described in more detail with reference to FIGS. 5, 8, and 9). PAD data may also be archived at this point for later “trend” analysis over extended periods of time (days, weeks, months).

At 350, the network management platform 180, such as with the fabric analysis module 190 or other components (not shown), operates to initiate traffic congestion alleviation actions. These actions may generally include performing maintenance (e.g., when a congestion source is a hardware problem such as a faulty switch or device port or a failing link), rerouting traffic in the fabric, adding capacity or additional fabric or edge devices, and other actions useful for addressing the specific fabric congestion pattern or problem that is detected in step 340. As additional examples, but not limitations, the “soft” recovery actions initiated at 350 may include: initiation of R_RDY flow control measures (e.g., withhold or slow down release of R_RDYs); initiation of Link Reset (LR/LRR) protocols; performing Fabric/N_Port logout procedures; and taking a congested port offline using OLS or other protocols. At 360, the process 300 continues with determination if congestion management is to continue, and if yes, the process 300 continues at 320. If not continued, the process 300 ends at 370.

With an understanding of the general operation of the system 100, it may be useful to take a detailed look at the operation of an exemplary switch in the monitored fabric 110, such as the switch 210, shown in FIG. 2. FIG. 4 illustrates generally functions performed during a switch congestion monitoring process 400. At 404, the process 400 is started and this generally involves loading or at least initiating a switch congestion analysis module 230 on the switches of a fabric 110. At 410, the switch 210 receives and stores user presets and policy values 258 for use in monitoring port congestion (or, alternatively, sets these values at default values). At 420, the PAD 254 is initialized. The PAD 254 is typically stored in volatile memory 250 and is initialized by creating fields for each port 212, 214, 216, 218 discovered or identified within the switch 210 and at this point, the port can be identified, the type of port determined, and port status and other operating parameters (such as capacities and the like) may be gathered and stored in the PAD in port-specific records 256. An individual port's record in the PAD will typically be reset when the port enters the active state.

At 426, the analysis module 230 determines whether a congestion sample period, such as 1 second or other relatively short time period, has expired and if not, the process 400 continues at 426. If the time period has expired or elapsed, the process 400 continues at 430 with the analysis module 230 pulling each active port's congestion management statistical data set from the congestion detection mechanisms 260, 262, 265, 266 with this data being stored at 257 in memory 250. At 440, the analysis module 230 performs congestion calculations to determine port specific congestion and provide a port centric view of congestion. At 450, the local PAD 254 is updated based on the status results from step 440 with each record 256 of ports with positive congestion values being updated (as is discussed in detail below). For detecting certain types of congestion, step 456 is performed to retrieve additional or “second pass” statistics, and when congestion is indicated based on the second pass statistics, the PAD records 256 are further updated. At 460, a request is received from the network management platform 180 or other interface, and the analysis module 230 responds by providing a copy of the requested records 256 or by providing all records (or select fields of some or all of the records) to the requesting device. Optionally, process 400 may include step 470 in which local logging is performed (such as updating congestion threshold logs, audit logs, and other logs). In these embodiments, the function 470 may include comparing such logs to threshold alert values and based on the results of the comparisons, generating congestion threshold alerts to notify users (such as via monitor 184 and GUI 186) of specific congested ports.

Because monitoring and detection of port congestion at each switch is an important feature of the invention, a more detailed description is provided for the operation of the switch congestion analysis module 230 and the switches in the system 100. Initially, it should be noted that congestion is independently monitored by the module 230 in both transmit and receive directions for each active port. Throughout this description, the terminology used to describe a detected congestion direction is switch specific (i.e., applicable at the switch level of operation), and as a result, a switch port in which congestion is preventing the timely transmission of egress data frames out of the switch is said to be experiencing TX congestion. A switch port that is not able to handle the in-bound frame load in a timely fashion is said to be experiencing RX congestion.

The detection of TX congestion in a port provides an indication that the directly attached device or switch is not satisfying the demands placed on it by the monitored switch port. The inability to meet the switch demands can arise from any of the three categories of congestion, i.e., resource limitations at a downstream device or switch port, over-subscription by the monitored switch, or secondary backpressure. The detection of RX congestion signifies that the switch port itself is not meeting the demands of an upstream node, and like TX congestion, RX congestion can be a result of any of the three types of fabric congestion. In most cases, congestion across a point-to-point link is predictable, e.g., is often mirror-image congestion. For example, if one side of an inter-switch link (ISL) is hampered by TX congestion, the adjacent or neighboring switch port on the other end of the ISL is likely experiencing RX congestion.

The switch congestion analysis module 230 utilizes a periodic algorithm that focuses on collecting input data on a per port basis, calculating congestion measurements in discrete categories, and then, providing a method for external user consumption and management station consumption and interpretation of the derived congestion data such as by an external user or via automatic analysis by the management station. The following paragraphs describe various features and functions of the analysis module 230 including algorithm assumptions, inputs, computations, outputs, and configuration options (e.g., settings of user presets and policies 258).

With regard to assumptions or bases for computations, the analysis module 230 uses an algorithm designed based upon the premise that during extended periods of frame traffic congestion with a fabric 110 one or more nodes within the fabric 110 may experience persistent and detectable congestion conditions that can be observed and recorded by the module 230. The module 230 assumes that there is a set of congestion configuration input values that can be set at default values or tuned by users in a manner to properly detect congestion levels of interest without excessively indicating congestion (i.e., without numerous false positives). At a low level, the congestion analysis module 230 functions to sample a set of port statistics 257 at small intervals to determine if one or more of the ports in the switch 210 is exhibiting behavior defined as congestive or consistent with known congestion patterns for a specific sample period. The derived congestion samples from each periodic congestion poll are aggregated into a congestion management statistics set which is retained within the PAD 254 in fields of the records 256. The PAD 254 is stored on the local switch 210 and can be retrieved by a management platform, such as platform 180 of FIG. 1, upon request. Additional data within the PAD 254 provides an association between congestion being felt by the port and the local switch ports, which may be the source of the congestion. In this manner, the analysis module 230 and PAD data 256 provide user visibility to the type, duration, and frequency of congestion being exhibited by a particular port. In some embodiments of the module 230, a user may be asynchronously notified of prolonged port congestion via use of congestion threshold alerts.

With regard to inputs or port statistics 257 used for detecting congestion, the module 230 gathers a diverse amount of statistical data 257 to calculate each port's congestion status (e.g., congestion type, level, and the like). The statistics gathered might vary depending on the ASICs provided in the ports that in turn affects the available congestion detection mechanisms 260, 262, 264, 266 available to the module 230. Generally, the port statistical data is divided into two discrete groups, i.e., primary and secondary statistic sets. The primary statistic set is used by the analysis module 230 to determine if the specific switch port is exhibiting behavior consistent with any of the three possible types of congestion during a sample period. The secondary statistic set is used to further help isolate the source of backpressure on the local switch that may be causing the congestion to be felt by a port.

The following are exemplary statistics that may be included in the primary congestion management port statistics: (1) TX BB_Credit level (i.e., time or percentage of time with zero TX BB_Credit); (2) TX link utilization; (3) RX BB_Credit levels (i.e., time or percentage of time with zero RX BB_Credit); (4) RX link utilization; (5) link distance; and (6) configured RX BB_Credit. Secondary congestion management port statistics are used to isolate ports that are congestion points on a local switch and may include the following: (1) “queuing latency” which can be used to differentiate high-link utilization from over-subscription conditions; (2) internal port transmit busy timeouts; (3) Class 3 frame flush counters/discard frame counters; (4) destination statistics; and (5) list of egress ports in use by this port. These statistics are intended to be illustrative of useful port data that can be used in determining port congestion, and additional (or fewer) port traffic statistics may be gathered and utilized by the module 230 in detecting and monitoring port-specific congestion. A foundation of the congestion detection and monitoring algorithm used by the analysis module 230 is the periodic gathering of these statistics or port data to derive port congestion samples (that are stored in records 256 of the PAD 254). The frequency of the congestion management polling in one preferred embodiment is initially set to once every second, which is selected because this time period prevents overloading of the CPU cycles required to support the control circuitry 213, 215, 217, 219, but other time periods may be used as required by the particular switch 210.

Each congestion polling or management period, the analysis module 230 examines the gathered port statistics 257 to determine if a port is being affected by congestion and the nature of the congestion. Congestion causes, according to the invention, fall into three high-level categories: resource limited congestion, over-subscription congestion, and backpressure congestion. If a congestion sample indicates that a port is exhibiting backpressure congestion, then a second statistics-gathering pass is performed to determine the likely sources of the backpressure within the local switch. Congestion samples or congestion data are calculated independently in the RX and TX directions. While the PAD 254 is preferably updated every management period, it is not necessary (nor even recommended) that management platforms refresh their versions of the PAD at the same rate. The format and data retention style of the PAD provides history information for the congestion management data since the last reset requested by a management platform. By providing the history data in this manner, multiple types of management platforms are able to calculate a change in congestion management statistics independently and simultaneously without impacting the switch's management period. Thus if management platform “A” wanted to look at the change in congestion statistics every 10 minutes and management platform “B” wanted to compare the congestion statistics changes every minute, each management application may do so by refreshing their congestion statistics at their fixed durations (10 minutes and 1 minute respectively) and comparing the latest sample with the previous retained statistics.

The congestion calculation operates similarly for F_Ports and E_Ports, but the potential cause and recommended response is different for each type of port. FIG. 6 illustrates an F_Port analysis chart 600 that shows in logical graph form the congestion types that can be detected by the module 230 using the underlying statistics for an F (or FL) port. Generally, axis 606 shows which direction traffic is being monitored for congestion as each port is monitored in both the RX and TX (or receiving/ingress and transmitting/egress) directions. The axis 602 shows the level of link utilization measured at the port. The settings of “Higher” and “Lower” may vary on a per-port basis or on a port-type basis to practice the invention, e.g., “Higher” may be defined as 70 to 100 percent of link capacity while “Lower” may be defined as less than about 30 percent of link capacity.

Box 610 represents a “well behaved device” in which a port has no unusual traffic patterns and utilization is not high. Box 614 illustrates an F_Port that is identified as congested in the RX direction but since link utilization is low, the module 230 determines that the cause is a busy device elsewhere and the congestion type backpressure (which is generated by the port in the RX direction). Box 618 indicates that the port is busy in the RX direction but not congested. However, at 620, backpressure congestion is detected at the port in the RX direction, as the port is not keeping up with frames being sent to the port. Hence, the port generates backpressure and the module 230 determines a likely cause to be over-subscription of the RX device. Box 626 illustrates a TX loaded device with lower utilization in which backpressure congestion is detected, but since utilization is low, the module 230 determines a likely cause of congestion is a slow drain device linked to the F or FL_Port. Box 630 illustrates a port identified as busy but not congested. At 636, the device is detected to be experiencing backpressure congestion and with high utilization in a TX device, the cause is determined to potentially be an over-subscribed TX device. Boxes 640, 650, and 660 are provided to show that the monitored F or FL_Port may have the same congestion status in both the RX and TX directions.

FIG. 7 is a similar logical graph of congestion analysis 700 of an E_Port with the axis 704 showing levels of link utilization and axis 708 indicating which direction of the port is being monitored. At box 710 the ISL is determined to be well behaved with no congestion issues. At box 712, low utilization is detected but backpressure congestion is being generated, and the module 230 determines that a busy device elsewhere may be the cause of congestion in the RX direction. At 714, the RX ISL is determined to be busy but not congested. At 716, backpressure congestion is being generated and the module 230 determines that the RX ISL is possibly congested. At 720, backpressure is detected in the TX direction, and because utilization is low, the module 230 determines that the source of congestion may be a throttled ISL. At box 724, the TX ISL is noted to be busy but not congested. At 728, backpressure is detected in the TX direction of the E_Port, and when this is combined with high link utilization, the module 230 determines that the TX ISL may be congested. As with FIG. 7, boxes 730, 736, and 740 are provided to indicate that the congestion status in the RX and TX directions of an E_Port may be identical (or may differ as shown in the rest of FIG. 7).

The output or product of the switch congestion analysis module 230 is a set of congestion data that is stored in the PAD 254 in port-specific congestion records 256. The module 230 processes port statistics 257 gathered once every sampling period to generate congestion management related data that is stored in the PAD 254. The PAD records 256 contain an entry or record for every port on the switch 210 and generally, each entry includes a port's simple port state (online or offline), a port type, a set of congestion management history counters or statistics, and in some embodiments, a mapping of possible TX congestion points or ports within a switch. The following is one example of how the records 256 in the PAD 254 may be defined.

TABLE 1
Port Activity Database Exemplary Record
Port Activity Database

| Field Name | Field Description |
|---|---|
| Simple Port | Boolean indication of whether the port is capable |
| State | (available) or incapable (unavailable) of frame |
| | transmission. |
| Established | The established port operating type (E-Port, F-Port, |
| Operating | FL-Port, etc.). |
| Type | |
| Congestion | A set of statistics based on the congestion management |
| Management | algorithm computations that are incremented over |
| Statistics | time. (See Table 2 for details) |
| Possible TX | Generally, a representation of each port on the local |
| Congestion | switch that may be causing backpressure to be felt by |
| Positional | the port associated with this port's PAD record entry. |
| Bitmap or | Two possible implementations are: (1) using a bit in a |
| A List of port | bit array to represent each port on the switch with a bit = |
| Identifiers | 1 meaning that the associated port is of interest and a |
| or Port | bit = 0 meaning the associated port is not contributing |
| Numbers | to the backpressure and (2) a list of port numbers or |
| | port identifiers where each port represented in the list |
| | is possibly contributing to the backpressure being |
| | detected by the port associated with this port's PAD |
| | entry. In the bit-map implementation, each bit set = 1 |
| | in this bitmap array represents a port on the local |
| | switch that may be causing backpressure to be felt by |
| | the port associated with this port's PAD record entry. |
| | The bit position associated with this port's PAD record |
| | entry is always set = 0. |

As discussed previously, the specific congestion management statistics generated by the module 230 and stored in the field shown in Table 1 may vary to practice the invention. However, to promote fuller understanding of the invention, Table 2 is included to provide a description, and in some cases, a result field and an action field for a number of useful congestion management statistics. Further, it will be understood that the descriptions are provided with the assumption, but not limitation, that the network management platform 180 is performing a delta calculation between reads of the statistic set over a fixed time window rather than raw statistic counts. These calculations are explained in more detail below with reference to the method shown in FIG. 5.

TABLE 2
Congestion Detection Statistics Set
Congestion Management Statistics

| Field Name | Field Information |
|---|---|
| PeriodInterval | Description: Number of milliseconds in a congestion |
| | management period. Each period the switch congestion |
| | management algorithm performs a computation to |
| | determine the congestion status of a port. Indications |
| | that a port may be congested result in the associated |
| | congestion management counter being incremented by 1. |
| TotalPeriods | Description: Number of congestion management periods |
| | whose history is recorded in the congestion management |
| | counters. Each congestion management period this count |
| | is incremented by 1. |
| UpdateTime | Description: Elapsed millisecond counter (32 bit running |
| | value) indicating the last time at which the congestion |
| | management counters were updated. |
| LastResetTime | Description: Elapsed millisecond counter (32 bit running |
| | value) indicating the last time at which the congestion |
| | management counters were reset. |
| RXOversubscribedPeriod | Description: Number of congestion management periods |
| | in which the attached device exhibited symptoms (high |
| | RX utilization, high ratio of time with 0 RX BB_Credit) |
| | consistent with an over-subscribed node, where the |
| | demand on this port greatly exceeds the port's line-rate |
| | capacity. |
| | Result: This port is possibly a congestion point, which |
| | results in backpressure elsewhere in fabric. |
| | Action: When the sliding window threshold (see |
| | description of the method of FIG. 5 for further |
| | explanation) is reached the management platform should |
| | notify the user that this is a possible congestion point |
| | with a reason code of “RX Oversubscription”. |
| RXBackpressurePeriod | Description: Number of congestion management periods |
| | in which this port registered symptoms (Low RX link |
| | utilization, high ratio of time with 0 RX BB_Credit) |
| | consistent with backpressure due to TX congestion points |
| | elsewhere on this switch. |
| | Result: This port is possibly congested with backpressure |
| | from a congestion point on this switch. |
| | Action: Examine other ports on this switch for possible |
| | TX congestion points that are resulting in this port being |
| | congested. |
| TXOversubscribedPeriod | Description: Number of congestion management periods |
| | in which the attached device exhibited symptoms (high |
| | TX utilization, high ratio of time with 0 TX BB_Credit) |
| | consistent with an over-subscribed node, where demand |
| | exceeds the port's line-rate capacity. |
| | Result: This port is possibly a congestion point that |
| | results in backpressure elsewhere in fabric. |
| | Action: When the sliding threshold is reached the |
| | management platform should notify the user that this is a |
| | possible congestion point with a reason code of “TX |
| | Oversubscription.” |
| TXResourceLimitedPeriod | Description: Number of congestion management periods |
| | in which the attached device exhibited symptoms (low |
| | TX utilization, high ratio of time with 0 TX BB_Credit) |
| | consistent with a resource bound link and did not appear |
| | to have insufficient TX BB_Credit |
| | Result: F-ports: This port is possibly a congestion point, |
| | which results in backpressure elsewhere in fabric. |
| | E-ports: This port is possibly congested with |
| | backpressure from a congestion point on the attached |
| | switch (or further behind that switch) |
| | Action: F-Ports: When the sliding threshold is reached |
| | the management platform should notify the user that this |
| | is a possible congestion point with a reason code of “TX |
| | Resource limited congestion.” |
| | E-Ports: Ensure that the TX credit on this switch is |
| | sufficient for the link distance being supported. Examine |
| | attached switch for congestion points. |

Each time congestion is detected by the module 230 after processing the latest congestion management statistics 257 sample the associated statistic in the congestion management statistics portion of the records 256 of the PAD 254 is incremented by one. During any one sample period, one or more (or none) of the congestion management statistics may be incremented based on the congested status of the port and congestion detection computation for that sample. While congestion indications for a single congestion period may not provide a very accurate view of whether a port is being adversely affected by congestion, examining the accumulation of congestion management or detection statistics over time (e.g., across several congestion management periods) provides a relatively accurate representation of a port's congestion state.

As noted in FIG. 4 at 410, the analysis module 230 allows a user to provide input user threshold and policy values (stored at 258 in switch memory 250) to define, among other things, the tolerance levels utilized by the module to flag or detect congestion (e.g., when to increment statistic counters). Due to the subjective nature of determining what is “congestion” or a bottleneck within a fabric, it is preferable that the module 230 has reasonable flexibility to adjust its congestion detection functions. However, because there are many internal detection parameters, ports can change configuration dynamically, and different traffic patterns can be seen within different fabrics, it is desirable to balance absolute configurability against ease of use. To this end, a group of high-level configuration options are typically presented to a user, such as via GUI 186, at the switch 230, or otherwise, that provides simple global configuration of congestion detection features of the system 100, without precluding a more detailed port-based configuration.

To this end, one embodiment of the system 100 utilizes policy-based configuration instead of the alternative option used in some embodiments of port-based configuration. Policy-based configuration permits a user to tie a few sets of rules together to form a policy that may then be selectively applied to one or more ports. Policy-based configuration differs from port centric configuration in that instead of defining a set of rules at every port, a handful of global policies are defined and each policy is directly or indirectly associated with a group of ports. Such policy-based configuration may include allowing the user to set a scope attribute that specifies the set of ports on which the policy will be enforced. Different possibilities exist for specifying the ports affected by a policy including: a port list (e.g., the user may create an explicit list of port numbers detailing the ports affected by a policy); E, F, or FL_Ports (e.g., the user may designate that a policy is to be applied to all ports with a particular operating state; and default (e.g., a policy may be applied to all ports not specifically covered by another policy).

To help alleviate some of an operator's uncertainty in defining congestion management configurations, a more coarse approach toward configuration management policy setting is used in many embodiments of the invention. In these embodiments, a setting field (in user presets and policies 258) is provided to hold the user input. The user input is used to adjust the behavior of the module 230 to detect congestion at a port within three tiers or levels of congestion sensitivity (although, of course, fewer or greater numbers of tiers may be used while still providing the setting feature). The setting field offers a simple selection indicating the level of congestion the analysis module 230 will detect, with the actual detailed parametric configuration used by the module 230 being hidden from the user. In one embodiment, the three tiers are labeled “Heavy”, “Moderate”, and “Light.” The “Heavy” setting is used when a user only wants the module 230 to detect more severe cases of fabric congestion, the “Light” setting causes the module 230 to detect even minor congestion, and the “Moderate” setting causes the module 230 to capture congestion events at a point below the “Heavy” cutoff but less sensitive than the “Light” setting. The boundaries or separation points between each setting may be user defined or set by default. Each setting corresponds to a group of congestion management parameters. When the user selects one of the three settings within a policy, the congestion detection by the module 230 for ports affected by that policy is performed using a group of static threshold values (stored at 258) as shown in Table 3.

TABLE 3
Example Settings for Various Congestion
Detection Statistics or Parameters
Congestion Management Configuration
Data Set (with exemplary setting cutoffs)

| | Setting | | |
|---|---|---|---|
| Detection Parameter | Light | Moderate | Heavy |
| RX high link utilization | 60% | 75% | 87% |
| percentage | | | |
| TX high link utilization | 60% | 75% | 87% |
| percentage | | | |
| RX low link utilization | 59% | 44% | 32% |
| percentage | | | |
| TX low link utilization | 59% | 44% | 32% |
| percentage | | | |
| Unstable TX Credit (Ratio | 50% | 70% | 85% |
| of Time spent with 0 TX | | | |
| Credit) | | | |
| Unstable RX Credit (Ratio | 50% | 70% | 85% |
| of time spent with 0 TX- | | | |
| Credit) | | | |

As noted at step 470 in FIG. 4, the switch congestion analysis module 230 may be operable to directly notify a user of port-centric congestion. In one embodiment, the module 230 has two modes of providing congestion data to a user—an asynchronous mode and a synchronous mode. One technique for notifying a user involves reporting congestion management data from the PAD 254 by displaying (or otherwise providing) in a display at the user interface 186. An alternate or additional user choice of congestion notification can be an asynchronous reporting mode that uses Congestion Threshold Alerts (CTAs). The asynchronous mode or technique for reporting a port-centric view of congestion is via a congestion threshold alert containing one or more of the congestion management statistics in the PAD 254. CTAs provide asynchronous user notification when a port's statistic counter(s) are incremented more than a configured threshold value (such as one set in user presets 258) within a given time period. At configuration, CTAs may be set for all E_Ports, for all F_Ports, or on a user-selected port list.

While the CTAs and other reporting capabilities of the switch module 230 can be used to provide a port-centric view of frame traffic congestion, a valuable portion of the invention and system 100 is that the system 100 is operable to provide fabric centric or fabric wide congestion detection, monitoring, reporting, and management. The network management platform 180 is operable to piece together, over time, a snapshot of fabric congestion and to isolate the source(s) of the fabric congestion. Over a fixed duration of time or fabric congestion monitoring period, the accumulation of the congestion management statistics at each switch begins to provide a fairly accurate description of fabric congestion locations. However, as the counters continue to increment for days, weeks, or even months, congestion management statistics become stale and begin to lose their usefulness since they no longer provide a current view of congestion in the monitored fabric. Therefore, an important aspect of the system 100 is its ability to accurately depict fabric congestion levels and isolate fabric congestion sources by properly calculating changes in the congestion management statistics for smaller, fixed windows of time.

FIG. 5 provides an overview of the processes performed by the network management platform 180 and specifically, the fabric congestion analysis module 190. As illustrated, the fabric congestion detection and monitoring process 500 begins at 506 such as with the configuration of the platform 180 to run the fabric congestion analysis module 190 and linking the platform 180 with the switches in the fabric 110. At 510, the congestion statistics threshold values are set for use in determining fabric congestion (as explained in more detail in the examples of fabric congestion management provided below). At 520, a detection interval is set for retrieving another set of congestion data (i.e., PAD 254 data) 194 from each switch in the monitored fabric 110. For example, data may be gathered every minute, every 5 minutes, every 10 minutes, and the like. At 530, the module 190 determines if the detection interval has elapsed and if not, repeats step 530. When the interval has elapsed, the process 500 continues at 536 with the module 190 polling each selected switch in the fabric 110 to request a current set of port congestion statistics, e.g., copies of PAD records for the active switch ports, which are stored in memory 192 at 194 to provide a history of per port congestion status in the fabric 110.

At 540, the module 190 functions to determine a delta or change between the previously obtained samples and the current sample and these calculated changes are stored in memory 192 at 196. At 550, the module 190 determines a set of fabric centric congestion states for each switch in the monitored fabric 110. Typically, fabric congestion is determined via a comparison with the appropriate threshold values 198 for the particular congestion statistic. At 560, the module 190 extrapolates the per port history of individual switch states to provide a fabric centric congestion view. Extrapolation typically includes a number of activities. The current port congestion states, as indicated in the most recent PAD collected from that switch, are compared with previous port congestion states collected from earlier PAD samples for that switch, on a per port and per switch basis throughout the Fabric and a “summary PAD” is generated for each switch using the results of the comparison. A “current” overview, at the switch level, of congestion throughout the Fabric is established as a result of creating the “summary PADs”. This view is represented in the implementation as a list of switch domain ID's, referred to as the Congestion Domain List (CDL). If none of the ports associated with a particular switch are indicating congestion, then that switch Domain ID will not be included in the CDL.

The next step involves processing of the CDL in order to determine the sources of congestion on the switches identified in the CDL. This step includes the use of the individual switch routing tables and zone member sets to identify ISLs connecting adjacent switches as well as to establish connectivity relationships between local switch ports. With this information available, the Fabric analysis module proceeds to associate congested “edge” ports on the identified switches and/or ISLs interconnecting the switches with the source(s) of the congestion, i.e. other edge ports on the local switch, other edge ports on other switches, and/or other ISLs.

The module 190 also acts at 560 to generate a congestion status display (such as those shown in FIGS. 8 and 9) that is displayed in the GUI 186 on monitor 184 for viewing by a user or fabric administrator. Preferably, the status display includes information such as congestion points, congestion levels, and congestion types to allow a user to better address the detected congestion in the fabric 110. The process 500 ends at 590 or is continued or repeated by returning to 530 to detect the lapsing of another fabric congestion detection or monitoring interval.

To supplement the explanation of the operation of the network management platform 180 and fabric centric congestion management, the following paragraphs provide addition description of the functions of the module 190. After this description, a number of examples of operation of the system 100 to detect port congestion and fabric congestion are provided along with a discussion of useful congestion status displays with reference to FIGS. 8 and 9. After fetching the congestion management data 194 from the fabric switches, the fabric congestion analysis module 190 performs at 550 a delta calculation between the new set of statistics and a previously retained statistical data set in order to calculate a difference in the congestion management statistical counters for the associated ports for a fixed time duration. By doing such a delta calculation, the module 190 is in effect throwing out stale data and is able to obtain a better picture or definition of the latest congestion effects being experienced within the monitored fabric. A series of such delta calculations provides the management platform with a sliding window view of current congestion behavior on the associated switches within the fabric.

For example, a fabric module 190 that is retrieving PAD data from a switch at 1-minute intervals and wants to examine the congestion status on a port over a 5-minute sliding window would retrieve and retain 5 copies of PAD data from the switch containing the port (i.e., one at the current time, t, and another set at each t-1 minute, t-2 minutes, t-3 minutes, and t-4 minutes). When a new sample is gathered, the module 190 compares the current sample with the earliest sample retained (i.e., t-4 minute sample) to determine the change in congestion management statistics over the last 5 minutes (i.e., the congestion detection period for the module 190). The new sample would be retained by the module 190 for later comparison while the sample at time t-4 minutes would be discarded from memory or retained for later “trend” analysis over larger time frames.

Fabric centric congestion detection is useful in part because congestion within a fabric tends to ebb and flow as user demand and resource allocation change making manual detection nearly impossible. Additionally, by retaining a sliding window calculation, the module 190 can provide visual indications via a congestion status display of congestion being manifested by each fabric port or along selected frame traffic paths. Such a graphical representation of the congestion being felt at each port is easier to understand and better illustrates the nature and association congested ports have on neighboring ports. Additionally, the display can be configured such that a congested node reports the type of congestion being manifested. In preferred embodiments, the fabric congestion status display comprises a graphical representation of the congestion effects being felt on all switches, ports, and ISL interconnects. Congestion is monitored and indicated independently in the RX and TX directions. Congestion is depicted at varying levels, such as three or more levels (i.e., high, medium, and low or other useful levels). Further, in some cases, colors or animation are added to the display to provide an indication of these levels (although the levels may be indicated with text or symbols). For example, each of the levels may be indicated by displaying the node, icon, or congestion status box in one of three colors corresponding to the three levels of congestion (i.e., red, yellow, and green corresponding to high, medium, and low).

FIG. 8 illustrates a user interface 800 in which a fabric congestion status display 810 is provided for viewing by a user. As shown, the display illustrates a fabric comprising a pair of switches connected by ISLs via E_Ports and a number of edge devices connected by bi-directional links to the switch F_Ports. In display 810, the congestion monitoring or management functions of system 100 have either not yet been activated or there has not yet been any congestion detected (i.e., all devices are well behaved using the terminology of FIGS. 6 and 7). FIG. 9 illustrates a user interface 900 in which a fabric congestion status display 910 is provided for the system or fabric shown in FIG. 8 but for which congestion management or monitoring has been activated and for which congestion has been detected. As shown, only the congested devices are included in the display 910 (but, of course, the well behaved devices may be included in some embodiments) along with switches 920, 930. The type of detected congestion being shown in text boxes 902, 904, 906, 912, 916, 934, 938 on the links between devices and with the direction congestion was detected indicated by the link arrow. The sources of congestion that have been detected are shown with text balloons 926, 940. Further, levels of congestion are indicated by the color of the text box or balloon as being red, yellow, or green that correspond to high, medium, and low levels of congestion. Preferably, the display 910 is updated when the fabric congestion detection interval elapses (such as once every minute or once every five minutes or the like) to provide a user with a current snapshot of the congestion being experienced in the monitored fabric.

The following examples provide details on the operation of the system 100 of FIG. 1 to determine congestion within a fabric at the port level and at the fabric level. Specifically, Example 1 shows how the congestion statistic calculation is performed for a single port, and Example 2 builds on Example 1 and provides a look at how a Counter Threshold Alert may be handled based on the calculated congestion management statistical set of Example 1. Example 3 depicts a method of determining fabric level congestion detection.

In Examples 1-3, the following configuration data is applied via policy-based configuration.

TABLE 4
Congestion Management Examples Defaults
Congestion Management Configuration Data Set

| Configuration Field | Value |
|---|---|
| Name | Device Congestion Parameters |
| Setting | Moderate |
| Scope | Port List |
| Ports | Ports 0, 1, 2, 3, 4, 5, 6, 7, 8 |
| Enabled | True |

In Table 4, the setting of “Moderate” indicates a particular detection configuration that provides the limits at which the switch congestion analysis module 230 begins to increment congestion statistics. The limits are shown below in Table 5.

TABLE 5
Example Threshold Values for “Moderate” Setting

| Parameter Threshold | Value |
|---|---|
| RX High utilization percentage | 75% |
| TX High utilization percentage | 75% |
| RX Low utilization percentage | 44% |
| TX Low utilization percentage | 44% |
| Unstable TX Credit (Ratio of Time | 70% |
| spent with 0 TX Credit) | |
| Unstable RX Credit (Ratio of Time | 70% |
| spent with 0 TX Credit) | |

### EXAMPLE 1

### Congestion Statistics Calculations

The congestion management statistics are calculated by the switch module 230 once every “congestion management period” (by default, once per second) for each active port in the switch. Every period, the switch module 230 examines a set of statistics per port to determine if that port is showing any signs of congestion. If the gathered statistics meet the qualifications used to define congestion behavior, then the associated congestion management statistic is incremented for that port. If RX backpressure congestion is being detected by a port during a congestion management period, a second pass of gathering data is performed to help isolate the likely causes of the congestion with respect to the local switch.

When the switch module 230 is invoked, it collects the following statistics from the congestion detection mechanisms in the port control circuitry: (1) RX utilization percentage of 21 percent; (2) TX utilization percentage of 88 percent; (3) unstable RX credit ratio of 84 percent; and (4) unstable TX credit ratio of 83 percent. The terms “unstable RX Credit” and “unstable TX BB_Credit” refer to extended periods of time when “RX BB_Credit=0” conditions exist and “TX BB_Credit=0” conditions exist, respectively. When the switch module 230 processes these statistics with reference to the “moderate” thresholds, the module 230 detects congestion in both the TX and RX direction. In the RX direction, low link utilization accompanied by a high percentage of time with no credit indicates that the ingress frames being received by the port cannot be forwarded on due to congestion elsewhere on the switch (see FIG. 6). For the TX direction, a high link utilization and a high ratio of time without transmit credit could mean that the link demand in the transmit direction is greater than the link capacity (or it could mean a highly efficient link, which provides an indication why one sample is not always useful for accurately detecting congestion but instead persistent or ongoing indications are more desirable). The congestion management statistics for this port would then have the following values in its PAD record or PAD entry: (1) period interval at 1 second; (2) total periods at 1; (3) RX over-subscribed period at zero; (4) RX backpressure period at 1; (5) TX over-subscribed period at 1; and (6) TX resource limited period at zero.

Regardless of the port type, congestion was detected in the RX direction (i.e., frames received from an external source) for this sample. Thus, the module 230 performs a second pass of data gathering in order to isolate the potential ports local to this switch that may be causing the congestion. For the second pass, the following data is retrieved in this example to help isolate the local port identifiers that are causing this port to be congested in the RX direction: Queuing latency, internal port transmit busy timeouts, and Class 3 frame flush counter/discarded frame counter. From this data set, a bit-mask of port identifiers by port number or a list of port numbers or port identifiers is created by the module 230 to represent the likely problem ports on the switch. The port bit-mask or port list of potential congestion sources is added as part of the port's PAD record or entry. The process described for this port would then be repeated after the lapse of a congestion management period (or in this case, 1 second) with the counters being updated when appropriate. The module 230 would also be performing similar analysis and maintaining of PAD entries for all the other active ports on the local switch.

### EXAMPLE 2

### Congestion Management Counter Threshold Alerts

Congestion Threshold Alerts (CTAs) are used in some cases by the switch congestion analysis module 230 to provide notification to management access points when a statistical counter in the congestion management statistical set 256 in the PAD 254 on the switch has exceeded a user-configurable threshold 258 over a set duration of time. A CTA may be configured by a user with the following exemplary values: (1) Port List/Port Type set at “All F_Ports”; (2) CTA Counter set at “TX Over-subscribed Periods”; (3) Increment Value set at “40”; and (4) Interval Time set at “10 minutes”. Thus, if the TX Over-subscribed period counter is incremented in the PAD entry for any F_Port 40 times or more within any 10 minute period then user notification is sent by the module 230 to the associated management interfaces.

### EXAMPLE 3

### Fabric Management and Congestion Source Isolation

In order to accurately depict a congested fabric view, the fabric congestion analysis module 190 on the management platform 180 keeps an accurate count of the changes in congestion management statistics over a set period of time for each port on the fabric. The module 190 also provides one or more threshold levels for each configuration statistic across the interval history time. These levels may be binary (e.g., congested/uncongested) or may be tiered (e.g., high, medium, or light (or no) congestion). For illustration purposes, Table 6 presents a model of an illustrative congestion management statistic threshold level table that may reside in memory 192 at 196 or elsewhere that is accessible by the fabric module 190.

TABLE 6
Congestion Threshold Limits

| | Threshold Level | | | |
|---|---|---|---|---|
| | (for 5 minute period - | | | |
| | 300 congestion periods) | | Port's Relationship | |
| Statistical Counter | Medium | High | to Congestion Source | Action |
| RXOversubscribedPeriod | 100 | 200 | Congestion Source in RX direction | Look for TX congestion on this switch |
| RXBackpressurePeriod | 100 | 200 | Congestion Source in RX direction | Look for TX congestion on this switch |
| TXOversubscribedPeriod | 100 | 200 | Link is Congestion Source, or Congestion | Follow link to next node |
| | | | Source in TX direction | |
| TXResourceLimitedPeriod | 100 | 200 | Congestion Source in TX direction | Follow link to next node |

By maintaining a history of the congestion statistics set and having congestion statistics threshold values for use in comparisons with statistics set values, the fabric module 190 has enough data to accurately model and depict the fabric level congestion for each port and path in a monitored fabric (such as in a status display shown in FIG. 9) and to trace congestion through the fabric.

Fabric level congestion detection according to some embodiments of the invention can be thought of as generally involving the following:
1) PAD data read is read from each switch, and congested ports are identified. For each congested port, the nature of the congestion is classified as either resource limited congestion, over-subscription congestion, or backpressure congestion.
2) Congested F and FL_Ports are connected to “edge” devices in the Fabric.
3) Congestion sources of these F and FL_Ports are identified on a switch-by-switch basis.
4) If source of congestion is from F/FL_Port(s) on same switch, the detection algorithm is complete for these ports. Management platform updates GUI display to identify congested ports to the user.
5) If source of congestion is an E_Port on same switch, routing table entries and zone set member information is used to determine the adjacent switch and associated port identifier(s) across the connecting ISL.
6) The above process is iterative until corresponding F/FL_Ports are identified as source of congestion. This may require following congestion across multiple ISLs and associated switches. Management platform updates GUI display to identify sources of congested ports to the user.

To supplement the explanation of the above generalized steps, the following paragraphs provide additional details on one embodiment of the fabric level congestion detection algorithm.

For each individual receive (ingress) port suffering backpressure congestion, a management station or other apparatus may use the following means to identify the likely cause(s) of said backpressure congestion:
1) Determine those transmit (egress) ports on the same switch as said backpressured port for which the average transmit queue length within said backpressured port exceeds a pre-determined threshold typically associated with high queuing latency.
2) Among said transmit ports determined above decide whether any are themselves congested. These congested port(s) are likely causes of the backpressure affecting the said backpressured port, if they are either F or FL_Ports or if they are resource-limited or oversubscribed E_Ports. Those ports among said transmit ports that are themselves backpressured are not the causes of said backpressure congestion, but the same means, starting with step 1) above, may now be used to determine what transmit ports are causing their congestion.

Steps 1 and 2 above may be used to determine any cause(s) of said backpressure congestion in ports one ISL hop away, then two ISL hops away, etc. until there are no new backpressured ports detected in steps 1 and 2, or until a loop is identified as explained in the following: It is possible that in repeating the steps 1 and 2 a loop will be identified, in which one transmit port is backpressured by another transmit port, which in turn is backpressured by a third, leading eventually to a port that backpressures the first transmit port. In this case the loop itself is the probable cause of the congestion and there may be no actual resource-limited or oversubscribed links causing the congestion.

Step 1 above specified comparing the average transmit queue size in a receive port against a threshold to decide whether a transmit port belonged in the list referred to in step 2. One skilled in the art will realize that average waiting time at the head of a queue, average queuing latency, and other criteria and combinations of criteria, such as percentage of time spent with 0 TX BB_Credit, may be used instead depending on the implementation.

To yet further clarify some of the unique features of the invention, it may be useful to provide a couple of congestion management examples. In the first congestion management example, two servers (server #1 and server #2) are each connected to separate 1 Gbps ingress ports on switch “A”. Switch “A” is connected via a 1 Gbps ISL link to switch “B”. One 1 Gbps egress port on switch “B” is connected to a storage device #3 and another 1 Gbps egress port on switch “B” is connected to storage device #4. Server #1 is transmitting at 100% line rate (1 Gbps) to storage device #3 and server #2 transmitting at 50% line rate (0.5 Gbps) to storage device #4. The 1 Gbps ISL between switch “A” and switch “B” is oversubscribed by 50% so a high link utilization rate is detected on both switches across the ISL. The RX buffers for the ingress ISL port on switch “B” become full and the associated RX BB_Credit=0 time increases. Congestion is reported to the management platform. Likewise, TX BB_Credit=0 conditions are detected on the egress ISL port on switch “A”, and congestion is reported to the management platform. Congestion analysis indicates that the ingress port attached to server #1 on switch “A” is responsible for the ISL over-subscription condition. A management request is issued to switch “A” to slow down the release of R_RDY Primitive Signals by 50% to server #1 thus slowing down the rate at which server #1 can send frames over the shared ISL between switch “A” and switch “B”. Since both server #1 and server #2 are now both only using 50% of the ISL bandwidth, congestion over the ISL is reduced.

In a second example, two servers (server #1 and server #2) each are connected to separate 1 Gbps ingress ports on switch “A”. Switch “A” is connected via a 1 Gbps ISL link to switch “B”. One 1 Gbps egress port on switch “B” is connected to a storage device #3 and another 1 Gbps egress port on switch “B” is connected to storage device #4. Server #1 is transmitting at 50% line rate (e.g., 0.5 Gbps) to storage device #3 and server #2 is transmitting at 50% line rate (e.g., 0.5 Gbps) to storage device #4. However, storage device #4 is a “slow drainer” and not consuming frames from switch “B” fast enough to prevent backpressure from developing over the ISL.

A low link utilization rate is detected across the ISL between switch “A” and switch “B”. This is because the RX buffers for the ingress ISL port on switch “B” have become full with frames destined for the “slow-drain” storage device #4 and the associated ISL RX BB_Credit=0 time increases. As a result, congestion is reported by the switch to the management platform. Likewise, TX BB_Credit=0 conditions are detected on the egress ISL port on switch “A”, and switch “A” reports congestion to the management platform. Second pass congestion analysis on switch “B” locates and reports the “slow drain” storage device #4 found on switch “B”.

Back-tracking to switch “A” across the ISL, further analysis by the management platform shows the ingress port attached to server #2 on switch “A” is generating the majority (if not all) of the frame traffic to the “slow-drain” storage device #4 on switch “B”. A management request is issued to switch “B” to take the egress port attached to “slow-drain” storage device #4 offline so that maintenance can be performed to remedy the problem. Since server #2 is no longer using the ISL to communicate with the slow-drain device, congestion over the ISL is reduced, if not eliminated.

The above disclosure sets forth a number of embodiments of the present invention. Other arrangements or embodiments, not precisely set forth, could be practiced under the teachings of the present invention and as set forth in the following claims.

1. A switch for use in a data storage network, comprising:
a plurality of ports each comprising a receiving device for receiving data from a link connected to the port and a transmitting device for transmitting data onto another link connected to the port;
a plurality of control circuits each associated with one of the ports, wherein each of the control circuits collects data traffic statistics and port state information for the associated port;
memory for storing a congestion record for each of the ports; and
a congestion analysis module gathering at least a portion of the data traffic statistics and port state information for the ports, performing computations with the gathered port statistics and port state information to detect congestion at the ports, and updating the congestion records for the ports with detected congestion.

2. The switch of claim 1, wherein the module periodically repeats the gathering, the performing, and the updating upon expiration of a sample time period.

3. The switch of claim 2, wherein the congestion records comprise counters for a set of congestion types and the updating of the congestion records comprises incrementing the counters for the ports for which the detected congestion corresponds to one of the congestion types.

4. The switch of claim 3, wherein the congestion types comprise backpressure congestion, resource limited congestion, and over-subscription congestion.

5. The switch of claim 4, wherein the module performs a second gathering of a second portion of the data traffic statistics for ones of the ports for which the detected congestion has the backpressure congestion type of congestion and then processes the second portion of the data traffic statistics to identify a source of backpressure within the switch.

6. The switch of claim 1, wherein the gathered port statistics are selected from the group consisting of TX BB_Credit levels, TX link utilization, RX BB_Credit levels, RX link utilization, link distance, configured RX BB_Credit, queuing latency, internal port transmit busy timeouts, Class 3 frame flush counters/discard frame counters, and destination statistics.

7. The switch of claim 1, wherein the gathered port statistics and port state information include separate sets of data for the receiving device and the transmitting device for the ports and wherein the performing computations comprises detecting congestion for the ports in the receiving device and the transmitting device based on the separate sets of data.

8. The switch of claim 1, wherein the memory further stores a set of congestion threshold values and wherein the performing congestion detection computations with the module comprises determining whether the gathered port statistics and port state information exceed the congestion threshold values.

9. The switch of claim 1, further comprising generating a Congestion Threshold Alert (CTA) indicating one or more congestion statistics to a log or management interface.

10. A method of managing congestion in a data storage fabric having a set of switches with input/output (I/O) ports and links connecting the ports for transferring digital data through the fabric, comprising:
receiving a first set of congestion data from the switches in the fabric, the first set comprising port-specific congestion data for the ports in the switches at a first time;
receiving a second set of congestion data from the switches in the fabric, the second set comprising port-specific congestion data for the ports in the switches at a second time; and
processing the first set and the second set of congestion data to determine a level of congestion at the ports.

11. The method of claim 10, wherein the processing comprises determining a change in the congestion data between the first and the second times.

12. The method of claim 11, wherein the determined change is used to update a set of congestion counters for each of the ports of each of the switches.

13. The method of claim 12, wherein the level of congestion is determined by comparing the congestion counters to threshold levels for a set of congestion types.

14. The method of claim 13, receiving from a user interface at least a portion of the threshold levels and displaying on the user interface at least a portion of the congestion counters.

15. The method of claim 13, wherein the congestion types comprise over-subscription in the receive and transmit directions, backpressure congestion in the receive direction, and resource-limited congestion in the transmit direction.

16. The method of claim 10, further comprising generating a congestion status display for viewing on a user interface comprising a graphical representation of the data storage fabric, the congestion status display including congestion indicators corresponding to the determined levels of congestion at the ports.

17. The method of claim 16, wherein the congestion data comprises detected types of congestion for the ports and the congestion status display includes congestion type indicators.

18. The method of claim 10, wherein the processing includes determining a source of the congestion in the fabric based on the congestion data.

19. A method for managing congestion in a fabric having a plurality of multi-port switches, comprising:
at each switch in the fabric, monitoring bi-directional traffic pattern data for each switch port for indications of congestion and when congestion is indicated for one of the switch ports, updating a congestion record for the congested port based on the monitored traffic pattern data;
operating the switches to transfer at least portions of the congestion records from each of the switches to a network management platform; and
at the network management platform, processing the transferred portions of the congestion records to determine a congestion status for the fabric.

20. The method of claim 19, further comprising performing congestion recovery comprising initiating manual intervention procedures or transmitting a congestion alleviation command to one of the switches based on the determined congestion status for the fabric.

21. The method of claim 19, wherein the processing comprises detecting a delta between the transferred portions of the congestion records and a set of previously received congestion records, and further wherein the congestion status comprises a congestion level and a congestion type for congested ones of the ports.

22. The method of claim 21, wherein the processing further includes determining a source of congestion in the fabric based on the types of congestion at the ports.

23. The method of claim 22, wherein the types of congestion comprise backpressure congestion, resource limited congestion, and over-subscription congestion.

24. The method of claim 19, wherein the monitoring at the switches is performed independently in a received direction and in a transmit direction for each of the ports.
